SEQUENCE LISTING (250 sequences)

SEQ ID NO: 1 - DNA, 52 bp, Artificial Sequence
  Fusion Primer A-MID1-11F
gcctccctcgcgccatcagacgagtgcgtgcaatttaggtatgaaagccagc

SEQ ID NO: 2 - DNA, 52 bp, Artificial Sequence
  Fusion Primer A-MID2-11F
gcctccctcgcgccatcagacgctcgacagcaatttaggtatgaaagccagc

SEQ ID NO: 3 - DNA, 52 bp, Artificial Sequence
  Fusion Primer A-MID3-11F
gcctccctcgcgccatcagagacgcactcgcaatttaggtatgaaagccagc

SEQ ID NO: 4 - DNA, 52 bp, Artificial Sequence
  Fusion Primer A-MID4-11F
gcctccctcgcgccatcagagcactgtaggcaatttaggtatgaaagccagc

SEQ ID NO: 5 - DNA, 52 bp, Artificial Sequence
  Fusion Primer A-MID5-11F
gcctccctcgcgccatcagatcagacacggcaatttaggtatgaaagccagc

SEQ ID NO: 6 - DNA, 52 bp, Artificial Sequence
  Fusion Primer A-MID6-11F
gcctccctcgcgccatcagatatcgcgaggcaatttaggtatgaaagccagc

SEQ ID NO: 7 - DNA, 52 bp, Artificial Sequence
  Fusion Primer A-MID7-11F
gcctccctcgcgccatcagcgtgtctctagcaatttaggtatgaaagccagc

SEQ ID NO: 8 - DNA, 52 bp, Artificial Sequence
  Fusion Primer A-MID8-11F
gcctccctcgcgccatcagctcgcgtgtcgcaatttaggtatgaaagccagc

SEQ ID NO: 9 - DNA, 52 bp, Artificial Sequence
  Fusion Primer A-MID10-11F
gcctccctcgcgccatcagtctctatgcggcaatttaggtatgaaagccagc

SEQ ID NO: 10 - DNA, 52 bp, Artificial Sequence
  Fusion Primer A-MID11-11F
gcctccctcgcgccatcagtgatacgtctgcaatttaggtatgaaagccagc

SEQ ID NO: 11 - DNA, 52 bp, Artificial Sequence
  Fusion Primer A-MID13-11F
gcctccctcgcgccatcagcatagtagtggcaatttaggtatgaaagccagc

SEQ ID NO: 12 - DNA, 52 bp, Artificial Sequence
  Fusion Primer A-MID14-11F
gcctccctcgcgccatcagcgagagatacgcaatttaggtatgaaagccagc

SEQ ID NO: 13 - DNA, 52 bp, Artificial Sequence
  Fusion Primer A-MID15-11F
gcctccctcgcgccatcagatacgacgtagcaatttaggtatgaaagccagc

SEQ ID NO: 14 - DNA, 52 bp, Artificial Sequence
  Fusion Primer A-MID16-11F
gcctccctcgcgccatcagtcacgtactagcaatttaggtatgaaagccagc

SEQ ID NO: 15 - DNA, 52 bp, Artificial Sequence
  Fusion Primer A-MID17-11F
gcctccctcgcgccatcagcgtctagtacgcaatttaggtatgaaagccagc

SEQ ID NO: 16 - DNA, 52 bp, Artificial Sequence
  Fusion Primer A-MID18-11F
gcctccctcgcgccatcagtctacgtagcgcaatttaggtatgaaagccagc

SEQ ID NO: 17 - DNA, 52 bp, Artificial Sequence
  Fusion Primer A-MID19-11F
gcctccctcgcgccatcagtgtactactcgcaatttaggtatgaaagccagc

SEQ ID NO: 18 - DNA, 52 bp, Artificial Sequence
  Fusion Primer A-MID20-11F
gcctccctcgcgccatcagacgactacaggcaatttaggtatgaaagccagc

SEQ ID NO: 19 - DNA, 52 bp, Artificial Sequence
  Fusion Primer A-MID21-11F
gcctccctcgcgccatcagcgtagactaggcaatttaggtatgaaagccagc

SEQ ID NO: 20 - DNA, 52 bp, Artificial Sequence
  Fusion Primer A-MID22-11F
gcctccctcgcgccatcagtacgagtatggcaatttaggtatgaaagccagc

SEQ ID NO: 21 - DNA, 52 bp, Artificial Sequence
  Fusion Primer A-MID23-11F
gcctccctcgcgccatcagtactctcgtggcaatttaggtatgaaagccagc

SEQ ID NO: 22 - DNA, 52 bp, Artificial Sequence
  Fusion Primer A-MID24-11F
gcctccctcgcgccatcagtagagacgaggcaatttaggtatgaaagccagc

SEQ ID NO: 23 - DNA, 52 bp, Artificial Sequence
  Fusion Primer A-MID25-11F
gcctccctcgcgccatcagtcgtcgctcggcaatttaggtatgaaagccagc

SEQ ID NO: 24 - DNA, 52 bp, Artificial Sequence
  Fusion Primer A-MID26-11F
gcctccctcgcgccatcagacatacgcgtgcaatttaggtatgaaagccagc

SEQ ID NO: 25 - DNA, 52 bp, Artificial Sequence
  Fusion Primer A-MID27-11F
gcctccctcgcgccatcagacgcgagtatgcaatttaggtatgaaagccagc

SEQ ID NO: 26 - DNA, 52 bp, Artificial Sequence
  Fusion Primer A-MID28-11F
gcctccctcgcgccatcagactactatgtgcaatttaggtatgaaagccagc

SEQ ID NO: 27 - DNA, 52 bp, Artificial Sequence
  Fusion Primer A-MID29-11F
gcctccctcgcgccatcagactgtacagtgcaatttaggtatgaaagccagc

SEQ ID NO: 28 - DNA, 52 bp, Artificial Sequence
  Fusion Primer A-MID30-11F
gcctccctcgcgccatcagagactatactgcaatttaggtatgaaagccagc

SEQ ID NO: 29 - DNA, 52 bp, Artificial Sequence
  Fusion Primer A-MID31-11F
gcctccctcgcgccatcagagcgtcgtctgcaatttaggtatgaaagccagc

SEQ ID NO: 30 - DNA, 52 bp, Artificial Sequence
  Fusion Primer A-MID32-11F
gcctccctcgcgccatcagagtacgctatgcaatttaggtatgaaagccagc

SEQ ID NO: 31 - DNA, 52 bp, Artificial Sequence
  Fusion Primer A-MID33-11F
gcctccctcgcgccatcagatagagtactgcaatttaggtatgaaagccagc

SEQ ID NO: 32 - DNA, 52 bp, Artificial Sequence
  Fusion Primer A-MID34-11F
gcctccctcgcgccatcagcacgctacgtgcaatttaggtatgaaagccagc

SEQ ID NO: 33 - DNA, 52 bp, Artificial Sequence
  Fusion Primer A-MID35-11F
gcctccctcgcgccatcagcagtagacgtgcaatttaggtatgaaagccagc

SEQ ID NO: 34 - DNA, 52 bp, Artificial Sequence
  Fusion Primer A-MID36-11F
gcctccctcgcgccatcagcgacgtgactgcaatttaggtatgaaagccagc

SEQ ID NO: 35 - DNA, 52 bp, Artificial Sequence
  Fusion Primer A-MID37-11F
gcctccctcgcgccatcagtacacacactgcaatttaggtatgaaagccagc

SEQ ID NO: 36 - DNA, 52 bp, Artificial Sequence
  Fusion Primer A-MID38-11F
gcctccctcgcgccatcagtacacgtgatgcaatttaggtatgaaagccagc

SEQ ID NO: 37 - DNA, 52 bp, Artificial Sequence
  Fusion Primer A-MID39-11F
gcctccctcgcgccatcagtacagatcgtgcaatttaggtatgaaagccagc

SEQ ID NO: 38 - DNA, 52 bp, Artificial Sequence
  Fusion Primer A-MID40-11F
gcctccctcgcgccatcagtacgctgtctgcaatttaggtatgaaagccagc

SEQ ID NO: 39 - DNA, 52 bp, Artificial Sequence
  Fusion Primer A-MID41-11F
gcctccctcgcgccatcagtagtgtagatgcaatttaggtatgaaagccagc

SEQ ID NO: 40 - DNA, 52 bp, Artificial Sequence
  Fusion Primer A-MID42-11F
gcctccctcgcgccatcagtcgatcacgtgcaatttaggtatgaaagccagc

SEQ ID NO: 41 - DNA, 52 bp, Artificial Sequence
  Fusion Primer A-MID43-11F
gcctccctcgcgccatcagtcgcactagtgcaatttaggtatgaaagccagc

SEQ ID NO: 42 - DNA, 52 bp, Artificial Sequence
  Fusion Primer A-MID44-11F
gcctccctcgcgccatcagtctagcgactgcaatttaggtatgaaagccagc

SEQ ID NO: 43 - DNA, 52 bp, Artificial Sequence
  Fusion Primer A-MID45-11F
gcctccctcgcgccatcagtctatactatgcaatttaggtatgaaagccagc

SEQ ID NO: 44 - DNA, 52 bp, Artificial Sequence
  Fusion Primer A-MID46-11F
gcctccctcgcgccatcagtgacgtatgtgcaatttaggtatgaaagccagc

SEQ ID NO: 45 - DNA, 52 bp, Artificial Sequence
  Fusion Primer A-MID47-11F
gcctccctcgcgccatcagtgtgagtagtgcaatttaggtatgaaagccagc

SEQ ID NO: 46 - DNA, 52 bp, Artificial Sequence
  Fusion Primer A-MID48-11F
gcctccctcgcgccatcagacagtatatagcaatttaggtatgaaagccagc

SEQ ID NO: 47 - DNA, 52 bp, Artificial Sequence
  Fusion Primer A-MID49-11F
gcctccctcgcgccatcagacgcgatcgagcaatttaggtatgaaagccagc

SEQ ID NO: 48 - DNA, 52 bp, Artificial Sequence
  Fusion Primer A-MID50-11F
gcctccctcgcgccatcagactagcagtagcaatttaggtatgaaagccagc

SEQ ID NO: 49 - DNA, 52 bp, Artificial Sequence
  Fusion Primer A-MID51-11F
gcctccctcgcgccatcagagctcacgtagcaatttaggtatgaaagccagc

SEQ ID NO: 50 - DNA, 52 bp, Artificial Sequence
  Fusion Primer A-MID52-11F
gcctccctcgcgccatcagagtatacatagcaatttaggtatgaaagccagc

SEQ ID NO: 51 - DNA, 52 bp, Artificial Sequence
  Fusion Primer B-MID1-12R
gccttgccagcccgctcagacgagtgcgtctttcagcattttgacggcaacc

SEQ ID NO: 52 - DNA, 52 bp, Artificial Sequence
  Fusion Primer B-MID2-12R
gccttgccagcccgctcagacgctcgacactttcagcattttgacggcaacc

SEQ ID NO: 53 - DNA, 52 bp, Artificial Sequence
  Fusion Primer B-MID3-12R
gccttgccagcccgctcagagacgcactcctttcagcattttgacggcaacc

SEQ ID NO: 54 - DNA, 52 bp, Artificial Sequence
  Fusion Primer B-MID4-12R
gccttgccagcccgctcagagcactgtagctttcagcattttgacggcaacc

SEQ ID NO: 55 - DNA, 52 bp, Artificial Sequence
  Fusion Primer B-MID5-12R
gccttgccagcccgctcagatcagacacgctttcagcattttgacggcaacc

SEQ ID NO: 56 - DNA, 52 bp, Artificial Sequence
  Fusion Primer B-MID6-12R
gccttgccagcccgctcagatatcgcgagctttcagcattttgacggcaacc

SEQ ID NO: 57 - DNA, 52 bp, Artificial Sequence
  Fusion Primer B-MID7-12R
gccttgccagcccgctcagcgtgtctctactttcagcattttgacggcaacc

SEQ ID NO: 58 - DNA, 52 bp, Artificial Sequence
  Fusion Primer B-MID8-12R
gccttgccagcccgctcagctcgcgtgtcctttcagcattttgacggcaacc

SEQ ID NO: 59 - DNA, 52 bp, Artificial Sequence
  Fusion Primer B-MID10-12R
gccttgccagcccgctcagtctctatgcgctttcagcattttgacggcaacc

SEQ ID NO: 60 - DNA, 52 bp, Artificial Sequence
  Fusion Primer B-MID11-12R
gccttgccagcccgctcagtgatacgtctctttcagcattttgacggcaacc

SEQ ID NO: 61 - DNA, 52 bp, Artificial Sequence
  Fusion Primer B-MID13-12R
gccttgccagcccgctcagcatagtagtgctttcagcattttgacggcaacc

SEQ ID NO: 62 - DNA, 52 bp, Artificial Sequence
  Fusion Primer B-MID14-12R
gccttgccagcccgctcagcgagagatacctttcagcattttgacggcaacc

SEQ ID NO: 63 - DNA, 52 bp, Artificial Sequence
  Fusion Primer B-MID15-12R
gccttgccagcccgctcagatacgacgtactttcagcattttgacggcaacc

SEQ ID NO: 64 - DNA, 52 bp, Artificial Sequence
  Fusion Primer B-MID16-12R
gccttgccagcccgctcagtcacgtactactttcagcattttgacggcaacc

SEQ ID NO: 65 - DNA, 52 bp, Artificial Sequence
  Fusion Primer B-MID17-12R
gccttgccagcccgctcagcgtctagtacctttcagcattttgacggcaacc

SEQ ID NO: 66 - DNA, 52 bp, Artificial Sequence
  Fusion Primer B-MID18-12R
gccttgccagcccgctcagtctacgtagcctttcagcattttgacggcaacc

SEQ ID NO: 67 - DNA, 52 bp, Artificial Sequence
  Fusion Primer B-MID19-12R
gccttgccagcccgctcagtgtactactcctttcagcattttgacggcaacc

SEQ ID NO: 68 - DNA, 52 bp, Artificial Sequence
  Fusion Primer B-MID20-12R
gccttgccagcccgctcagacgactacagctttcagcattttgacggcaacc

SEQ ID NO: 69 - DNA, 52 bp, Artificial Sequence
  Fusion Primer B-MID21-12R
gccttgccagcccgctcagcgtagactagctttcagcattttgacggcaacc

SEQ ID NO: 70 - DNA, 52 bp, Artificial Sequence
  Fusion Primer B-MID22-12R
gccttgccagcccgctcagtacgagtatgctttcagcattttgacggcaacc

SEQ ID NO: 71 - DNA, 52 bp, Artificial Sequence
  Fusion Primer B-MID23-12R
gccttgccagcccgctcagtactctcgtgctttcagcattttgacggcaacc

SEQ ID NO: 72 - DNA, 52 bp, Artificial Sequence
  Fusion Primer B-MID24-12R
gccttgccagcccgctcagtagagacgagctttcagcattttgacggcaacc

SEQ ID NO: 73 - DNA, 52 bp, Artificial Sequence
  Fusion Primer B-MID25-12R
gccttgccagcccgctcagtcgtcgctcgctttcagcattttgacggcaacc

SEQ ID NO: 74 - DNA, 52 bp, Artificial Sequence
  Fusion Primer B-MID26-12R
gccttgccagcccgctcagacatacgcgtctttcagcattttgacggcaacc

SEQ ID NO: 75 - DNA, 52 bp, Artificial Sequence
  Fusion Primer B-MID27-12R
gccttgccagcccgctcagacgcgagtatctttcagcattttgacggcaacc

SEQ ID NO: 76 - DNA, 52 bp, Artificial Sequence
  Fusion Primer B-MID28-12R
gccttgccagcccgctcagactactatgtctttcagcattttgacggcaacc

SEQ ID NO: 77 - DNA, 52 bp, Artificial Sequence
  Fusion Primer B-MID29-12R
gccttgccagcccgctcagactgtacagtctttcagcattttgacggcaacc

SEQ ID NO: 78 - DNA, 52 bp, Artificial Sequence
  Fusion Primer B-MID30-12R
gccttgccagcccgctcagagactatactctttcagcattttgacggcaacc

SEQ ID NO: 79 - DNA, 52 bp, Artificial Sequence
  Fusion Primer B-MID31-12R
gccttgccagcccgctcagagcgtcgtctctttcagcattttgacggcaacc

SEQ ID NO: 80 - DNA, 52 bp, Artificial Sequence
  Fusion Primer B-MID32-12R
gccttgccagcccgctcagagtacgctatctttcagcattttgacggcaacc

SEQ ID NO: 81 - DNA, 52 bp, Artificial Sequence
  Fusion Primer B-MID33-12R
gccttgccagcccgctcagatagagtactctttcagcattttgacggcaacc

SEQ ID NO: 82 - DNA, 52 bp, Artificial Sequence
  Fusion Primer B-MID34-12R
gccttgccagcccgctcagcacgctacgtctttcagcattttgacggcaacc

SEQ ID NO: 83 - DNA, 52 bp, Artificial Sequence
  Fusion Primer B-MID35-12R
gccttgccagcccgctcagcagtagacgtctttcagcattttgacggcaacc

SEQ ID NO: 84 - DNA, 52 bp, Artificial Sequence
  Fusion Primer B-MID36-12R
gccttgccagcccgctcagcgacgtgactctttcagcattttgacggcaacc

SEQ ID NO: 85 - DNA, 52 bp, Artificial Sequence
  Fusion Primer B-MID37-12R
gccttgccagcccgctcagtacacacactctttcagcattttgacggcaacc

SEQ ID NO: 86 - DNA, 52 bp, Artificial Sequence
  Fusion Primer B-MID38-12R
gccttgccagcccgctcagtacacgtgatctttcagcattttgacggcaacc

SEQ ID NO: 87 - DNA, 52 bp, Artificial Sequence
  Fusion Primer B-MID39-12R
gccttgccagcccgctcagtacagatcgtctttcagcattttgacggcaacc

SEQ ID NO: 88 - DNA, 52 bp, Artificial Sequence
  Fusion Primer B-MID40-12R
gccttgccagcccgctcagtacgctgtctctttcagcattttgacggcaacc

SEQ ID NO: 89 - DNA, 52 bp, Artificial Sequence
  Fusion Primer B-MID41-12R
gccttgccagcccgctcagtagtgtagatctttcagcattttgacggcaacc

SEQ ID NO: 90 - DNA, 52 bp, Artificial Sequence
  Fusion Primer B-MID42-12R
gccttgccagcccgctcagtcgatcacgtctttcagcattttgacggcaacc

SEQ ID NO: 91 - DNA, 52 bp, Artificial Sequence
  Fusion Primer B-MID43-12R
gccttgccagcccgctcagtcgcactagtctttcagcattttgacggcaacc

SEQ ID NO: 92 - DNA, 52 bp, Artificial Sequence
  Fusion Primer B-MID44-12R
gccttgccagcccgctcagtctagcgactctttcagcattttgacggcaacc

SEQ ID NO: 93 - DNA, 52 bp, Artificial Sequence
  Fusion Primer B-MID45-12R
gccttgccagcccgctcagtctatactatctttcagcattttgacggcaacc

SEQ ID NO: 94 - DNA, 52 bp, Artificial Sequence
  Fusion Primer B-MID46-12R
gccttgccagcccgctcagtgacgtatgtctttcagcattttgacggcaacc

SEQ ID NO: 95 - DNA, 52 bp, Artificial Sequence
  Fusion Primer B-MID47-12R
gccttgccagcccgctcagtgtgagtagtctttcagcattttgacggcaacc

SEQ ID NO: 96 - DNA, 52 bp, Artificial Sequence
  Fusion Primer B-MID48-12R
gccttgccagcccgctcagacagtatatactttcagcattttgacggcaacc

SEQ ID NO: 97 - DNA, 52 bp, Artificial Sequence
  Fusion Primer B-MID49-12R
gccttgccagcccgctcagacgcgatcgactttcagcattttgacggcaacc

SEQ ID NO: 98 - DNA, 52 bp, Artificial Sequence
  Fusion Primer B-MID50-12R
gccttgccagcccgctcagactagcagtactttcagcattttgacggcaacc

SEQ ID NO: 99 - DNA, 52 bp, Artificial Sequence
  Fusion Primer B-MID51-12R
gccttgccagcccgctcagagctcacgtactttcagcattttgacggcaacc

SEQ ID NO: 100 - DNA, 52 bp, Artificial Sequence
  Fusion Primer B-MID52-12R
gccttgccagcccgctcagagtatacatactttcagcattttgacggcaacc

SEQ ID NO: 101 - DNA, 48 bp, Artificial Sequence
  Fusion Primer A-MID1-D835F
gcctccctcgcgccatcagacgagtgcgtgccgccaggaacgtgcttg

SEQ ID NO: 102 - DNA, 48 bp, Artificial Sequence
  Fusion Primer A-MID2-D835F
gcctccctcgcgccatcagacgctcgacagccgccaggaacgtgcttg

SEQ ID NO: 103 - DNA, 48 bp, Artificial Sequence
  Fusion Primer A-MID3-D835F
gcctccctcgcgccatcagagacgcactcgccgccaggaacgtgcttg

SEQ ID NO: 104 - DNA, 48 bp, Artificial Sequence
  Fusion Primer A-MID4-D835F
gcctccctcgcgccatcagagcactgtaggccgccaggaacgtgcttg

SEQ ID NO: 105 - DNA, 48 bp, Artificial Sequence
  Fusion Primer A-MID5-D835F
gcctccctcgcgccatcagatcagacacggccgccaggaacgtgcttg

SEQ ID NO: 106 - DNA, 48 bp, Artificial Sequence
  Fusion Primer A-MID6-D835F
gcctccctcgcgccatcagatatcgcgaggccgccaggaacgtgcttg

SEQ ID NO: 107 - DNA, 48 bp, Artificial Sequence
  Fusion Primer A-MID7-D835F
gcctccctcgcgccatcagcgtgtctctagccgccaggaacgtgcttg

SEQ ID NO: 108 - DNA, 48 bp, Artificial Sequence
  Fusion Primer A-MID8-D835F
gcctccctcgcgccatcagctcgcgtgtcgccgccaggaacgtgcttg

SEQ ID NO: 109 - DNA, 48 bp, Artificial Sequence
  Fusion Primer A-MID10-D835F
gcctccctcgcgccatcagtctctatgcggccgccaggaacgtgcttg

SEQ ID NO: 110 - DNA, 48 bp, Artificial Sequence
  Fusion Primer A-MID11-D835F
gcctccctcgcgccatcagtgatacgtctgccgccaggaacgtgcttg

SEQ ID NO: 111 - DNA, 48 bp, Artificial Sequence
  Fusion Primer A-MID13-D835F
gcctccctcgcgccatcagcatagtagtggccgccaggaacgtgcttg

SEQ ID NO: 112 - DNA, 48 bp, Artificial Sequence
  Fusion Primer A-MID14-D835F
gcctccctcgcgccatcagcgagagatacgccgccaggaacgtgcttg

SEQ ID NO: 113 - DNA, 48 bp, Artificial Sequence
  Fusion Primer A-MID15-D835F
gcctccctcgcgccatcagatacgacgtagccgccaggaacgtgcttg

SEQ ID NO: 114 - DNA, 48 bp, Artificial Sequence
  Fusion Primer A-MID16-D835F
gcctccctcgcgccatcagtcacgtactagccgccaggaacgtgcttg

SEQ ID NO: 115 - DNA, 48 bp, Artificial Sequence
  Fusion Primer A-MID17-D835F
gcctccctcgcgccatcagcgtctagtacgccgccaggaacgtgcttg

SEQ ID NO: 116 - DNA, 48 bp, Artificial Sequence
  Fusion Primer A-MID18-D835F
gcctccctcgcgccatcagtctacgtagcgccgccaggaacgtgcttg

SEQ ID NO: 117 - DNA, 48 bp, Artificial Sequence
  Fusion Primer A-MID19-D835F
gcctccctcgcgccatcagtgtactactcgccgccaggaacgtgcttg

SEQ ID NO: 118 - DNA, 48 bp, Artificial Sequence
  Fusion Primer A-MID20-D835F
gcctccctcgcgccatcagacgactacaggccgccaggaacgtgcttg

SEQ ID NO: 119 - DNA, 48 bp, Artificial Sequence
  Fusion Primer A-MID21-D835F
gcctccctcgcgccatcagcgtagactaggccgccaggaacgtgcttg

SEQ ID NO: 120 - DNA, 48 bp, Artificial Sequence
  Fusion Primer A-MID22-D835F
gcctccctcgcgccatcagtacgagtatggccgccaggaacgtgcttg

SEQ ID NO: 121 - DNA, 48 bp, Artificial Sequence
  Fusion Primer A-MID23-D835F
gcctccctcgcgccatcagtactctcgtggccgccaggaacgtgcttg

SEQ ID NO: 122 - DNA, 48 bp, Artificial Sequence
  Fusion Primer A-MID24-D835F
gcctccctcgcgccatcagtagagacgaggccgccaggaacgtgcttg

SEQ ID NO: 123 - DNA, 48 bp, Artificial Sequence
  Fusion Primer A-MID25-D835F
gcctccctcgcgccatcagtcgtcgctcggccgccaggaacgtgcttg

SEQ ID NO: 124 - DNA, 48 bp, Artificial Sequence
  Fusion Primer A-MID26-D835F
gcctccctcgcgccatcagacatacgcgtgccgccaggaacgtgcttg

SEQ ID NO: 125 - DNA, 48 bp, Artificial Sequence
  Fusion Primer A-MID27-D835F
gcctccctcgcgccatcagacgcgagtatgccgccaggaacgtgcttg

SEQ ID NO: 126 - DNA, 48 bp, Artificial Sequence
  Fusion Primer A-MID28-D835F
gcctccctcgcgccatcagactactatgtgccgccaggaacgtgcttg

SEQ ID NO: 127 - DNA, 48 bp, Artificial Sequence
  Fusion Primer A-MID29-D835F
gcctccctcgcgccatcagactgtacagtgccgccaggaacgtgcttg

SEQ ID NO: 128 - DNA, 48 bp, Artificial Sequence
  Fusion Primer A-MID30-D835F
gcctccctcgcgccatcagagactatactgccgccaggaacgtgcttg

SEQ ID NO: 129 - DNA, 48 bp, Artificial Sequence
  Fusion Primer A-MID31-D835F
gcctccctcgcgccatcagagcgtcgtctgccgccaggaacgtgcttg

SEQ ID NO: 130 - DNA, 48 bp, Artificial Sequence
  Fusion Primer A-MID32-D835F
gcctccctcgcgccatcagagtacgctatgccgccaggaacgtgcttg

SEQ ID NO: 131 - DNA, 48 bp, Artificial Sequence
  Fusion Primer A-MID33-D835F
gcctccctcgcgccatcagatagagtactgccgccaggaacgtgcttg

SEQ ID NO: 132 - DNA, 48 bp, Artificial Sequence
  Fusion Primer A-MID34-D835F
gcctccctcgcgccatcagcacgctacgtgccgccaggaacgtgcttg

SEQ ID NO: 133 - DNA, 48 bp, Artificial Sequence
  Fusion Primer A-MID35-D835F
gcctccctcgcgccatcagcagtagacgtgccgccaggaacgtgcttg

SEQ ID NO: 134 - DNA, 48 bp, Artificial Sequence
  Fusion Primer A-MID36-D835F
gcctccctcgcgccatcagcgacgtgactgccgccaggaacgtgcttg

SEQ ID NO: 135 - DNA, 48 bp, Artificial Sequence
  Fusion Primer A-MID37-D835F
gcctccctcgcgccatcagtacacacactgccgccaggaacgtgcttg

SEQ ID NO: 136 - DNA, 48 bp, Artificial Sequence
  Fusion Primer A-MID38-D835F
gcctccctcgcgccatcagtacacgtgatgccgccaggaacgtgcttg

SEQ ID NO: 137 - DNA, 48 bp, Artificial Sequence
  Fusion Primer A-MID39-D835F
gcctccctcgcgccatcagtacagatcgtgccgccaggaacgtgcttg

SEQ ID NO: 138 - DNA, 48 bp, Artificial Sequence
  Fusion Primer A-MID40-D835F
gcctccctcgcgccatcagtacgctgtctgccgccaggaacgtgcttg

SEQ ID NO: 139 - DNA, 48 bp, Artificial Sequence
  Fusion Primer A-MID41-D835F
gcctccctcgcgccatcagtagtgtagatgccgccaggaacgtgcttg

SEQ ID NO: 140 - DNA, 48 bp, Artificial Sequence
  Fusion Primer A-MID42-D835F
gcctccctcgcgccatcagtcgatcacgtgccgccaggaacgtgcttg

SEQ ID NO: 141 - DNA, 48 bp, Artificial Sequence
  Fusion Primer A-MID43-D835F
gcctccctcgcgccatcagtcgcactagtgccgccaggaacgtgcttg

SEQ ID NO: 142 - DNA, 48 bp, Artificial Sequence
  Fusion Primer A-MID44-D835F
gcctccctcgcgccatcagtctagcgactgccgccaggaacgtgcttg

SEQ ID NO: 143 - DNA, 48 bp, Artificial Sequence
  Fusion Primer A-MID45-D835F
gcctccctcgcgccatcagtctatactatgccgccaggaacgtgcttg

SEQ ID NO: 144 - DNA, 48 bp, Artificial Sequence
  Fusion Primer A-MID46-D835F
gcctccctcgcgccatcagtgacgtatgtgccgccaggaacgtgcttg

SEQ ID NO: 145 - DNA, 48 bp, Artificial Sequence
  Fusion Primer A-MID47-D835F
gcctccctcgcgccatcagtgtgagtagtgccgccaggaacgtgcttg

SEQ ID NO: 146 - DNA, 48 bp, Artificial Sequence
  Fusion Primer A-MID48-D835F
gcctccctcgcgccatcagacagtatatagccgccaggaacgtgcttg

SEQ ID NO: 147 - DNA, 48 bp, Artificial Sequence
  Fusion Primer A-MID49-D835F
gcctccctcgcgccatcagacgcgatcgagccgccaggaacgtgcttg

SEQ ID NO: 148 - DNA, 48 bp, Artificial Sequence
  Fusion Primer A-MID50-D835F
gcctccctcgcgccatcagactagcagtagccgccaggaacgtgcttg

SEQ ID NO: 149 - DNA, 48 bp, Artificial Sequence
  Fusion Primer A-MID51-D835F
gcctccctcgcgccatcagagctcacgtagccgccaggaacgtgcttg

SEQ ID NO: 150 - DNA, 48 bp, Artificial Sequence
  Fusion Primer A-MID52-D835F
gcctccctcgcgccatcagagtatacatagccgccaggaacgtgcttg

SEQ ID NO: 151 - DNA, 46 bp, Artificial Sequence
  Fusion Primer B-MID1-D835R
gccttgccagcccgctcagacgagtgcgtcagcctcacattgcccc

SEQ ID NO: 152 - DNA, 46 bp, Artificial Sequence
  Fusion Primer B-MID2-D835R
gccttgccagcccgctcagacgctcgacacagcctcacattgcccc

SEQ ID NO: 153 - DNA, 46 bp, Artificial Sequence
  Fusion Primer B-MID3-D835R
gccttgccagcccgctcagagacgcactccagcctcacattgcccc

SEQ ID NO: 154 - DNA, 46 bp, Artificial Sequence
  Fusion Primer B-MID4-D835R
gccttgccagcccgctcagagcactgtagcagcctcacattgcccc

SEQ ID NO: 155 - DNA, 46 bp, Artificial Sequence
  Fusion Primer B-MID5-D835R
gccttgccagcccgctcagatcagacacgcagcctcacattgcccc

SEQ ID NO: 156 - DNA, 46 bp, Artificial Sequence
  Fusion Primer B-MID6-D835R
gccttgccagcccgctcagatatcgcgagcagcctcacattgcccc

SEQ ID NO: 157 - DNA, 46 bp, Artificial Sequence
  Fusion Primer B-MID7-D835R
gccttgccagcccgctcagcgtgtctctacagcctcacattgcccc

SEQ ID NO: 158 - DNA, 46 bp, Artificial Sequence
  Fusion Primer B-MID8-D835R
gccttgccagcccgctcagctcgcgtgtccagcctcacattgcccc

SEQ ID NO: 159 - DNA, 46 bp, Artificial Sequence
  Fusion Primer B-MID10-D835R
gccttgccagcccgctcagtctctatgcgcagcctcacattgcccc

SEQ ID NO: 160 - DNA, 46 bp, Artificial Sequence
  Fusion Primer B-MID11-D835R
gccttgccagcccgctcagtgatacgtctcagcctcacattgcccc

SEQ ID NO: 161 - DNA, 46 bp, Artificial Sequence
  Fusion Primer B-MID13-D835R
gccttgccagcccgctcagcatagtagtgcagcctcacattgcccc

SEQ ID NO: 162 - DNA, 46 bp, Artificial Sequence
  Fusion Primer B-MID14-D835R
gccttgccagcccgctcagcgagagataccagcctcacattgcccc

SEQ ID NO: 163 - DNA, 46 bp, Artificial Sequence
  Fusion Primer B-MID15-D835R
gccttgccagcccgctcagatacgacgtacagcctcacattgcccc

SEQ ID NO: 164 - DNA, 46 bp, Artificial Sequence
  Fusion Primer B-MID16-D835R
gccttgccagcccgctcagtcacgtactacagcctcacattgcccc

SEQ ID NO: 165 - DNA, 46 bp, Artificial Sequence
  Fusion Primer B-MID17-D835R
gccttgccagcccgctcagcgtctagtaccagcctcacattgcccc

SEQ ID NO: 166 - DNA, 46 bp, Artificial Sequence
  Fusion Primer B-MID18-D835R
gccttgccagcccgctcagtctacgtagccagcctcacattgcccc

SEQ ID NO: 167 - DNA, 46 bp, Artificial Sequence
  Fusion Primer B-MID19-D835R
gccttgccagcccgctcagtgtactactccagcctcacattgcccc

SEQ ID NO: 168 - DNA, 46 bp, Artificial Sequence
  Fusion Primer B-MID20-D835R
gccttgccagcccgctcagacgactacagcagcctcacattgcccc

SEQ ID NO: 169 - DNA, 46 bp, Artificial Sequence
  Fusion Primer B-MID21-D835R
gccttgccagcccgctcagcgtagactagcagcctcacattgcccc

SEQ ID NO: 170 - DNA, 46 bp, Artificial Sequence
  Fusion Primer B-MID22-D835R
gccttgccagcccgctcagtacgagtatgcagcctcacattgcccc

SEQ ID NO: 171 - DNA, 46 bp, Artificial Sequence
  Fusion Primer B-MID23-D835R
gccttgccagcccgctcagtactctcgtgcagcctcacattgcccc

SEQ ID NO: 172 - DNA, 46 bp, Artificial Sequence
  Fusion Primer B-MID24-D835R
gccttgccagcccgctcagtagagacgagcagcctcacattgcccc

SEQ ID NO: 173 - DNA, 46 bp, Artificial Sequence
  Fusion Primer B-MID25-D835R
gccttgccagcccgctcagtcgtcgctcgcagcctcacattgcccc

SEQ ID NO: 174 - DNA, 46 bp, Artificial Sequence
  Fusion Primer B-MID26-D835R
gccttgccagcccgctcagacatacgcgtcagcctcacattgcccc

SEQ ID NO: 175 - DNA, 46 bp, Artificial Sequence
  Fusion Primer B-MID27-D835R
gccttgccagcccgctcagacgcgagtatcagcctcacattgcccc

SEQ ID NO: 176 - DNA, 46 bp, Artificial Sequence
  Fusion Primer B-MID28-D835R
gccttgccagcccgctcagactactatgtcagcctcacattgcccc

SEQ ID NO: 177 - DNA, 46 bp, Artificial Sequence
  Fusion Primer B-MID29-D835R
gccttgccagcccgctcagactgtacagtcagcctcacattgcccc

SEQ ID NO: 178 - DNA, 46 bp, Artificial Sequence
  Fusion Primer B-MID30-D835R
gccttgccagcccgctcagagactatactcagcctcacattgcccc

SEQ ID NO: 179 - DNA, 46 bp, Artificial Sequence
  Fusion Primer B-MID31-D835R
gccttgccagcccgctcagagcgtcgtctcagcctcacattgcccc

SEQ ID NO: 180 - DNA, 46 bp, Artificial Sequence
  Fusion Primer B-MID32-D835R
gccttgccagcccgctcagagtacgctatcagcctcacattgcccc

SEQ ID NO: 181 - DNA, 46 bp, Artificial Sequence
  Fusion Primer B-MID33-D835R
gccttgccagcccgctcagatagagtactcagcctcacattgcccc

SEQ ID NO: 182 - DNA, 46 bp, Artificial Sequence
  Fusion Primer B-MID34-D835R
gccttgccagcccgctcagcacgctacgtcagcctcacattgcccc

SEQ ID NO: 183 - DNA, 46 bp, Artificial Sequence
  Fusion Primer B-MID35-D835R
gccttgccagcccgctcagcagtagacgtcagcctcacattgcccc

SEQ ID NO: 184 - DNA, 46 bp, Artificial Sequence
  Fusion Primer B-MID36-D835R
gccttgccagcccgctcagcgacgtgactcagcctcacattgcccc

SEQ ID NO: 185 - DNA, 46 bp, Artificial Sequence
  Fusion Primer B-MID37-D835R
gccttgccagcccgctcagtacacacactcagcctcacattgcccc

SEQ ID NO: 186 - DNA, 46 bp, Artificial Sequence
  Fusion Primer B-MID38-D835R
gccttgccagcccgctcagtacacgtgatcagcctcacattgcccc

SEQ ID NO: 187 - DNA, 46 bp, Artificial Sequence
  Fusion Primer B-MID39-D835R
gccttgccagcccgctcagtacagatcgtcagcctcacattgcccc

SEQ ID NO: 188 - DNA, 46 bp, Artificial Sequence
  Fusion Primer B-MID40-D835R
gccttgccagcccgctcagtacgctgtctcagcctcacattgcccc

SEQ ID NO: 189 - DNA, 46 bp, Artificial Sequence
  Fusion Primer B-MID41-D835R
gccttgccagcccgctcagtagtgtagatcagcctcacattgcccc

SEQ ID NO: 190 - DNA, 46 bp, Artificial Sequence
  Fusion Primer B-MID42-D835R
gccttgccagcccgctcagtcgatcacgtcagcctcacattgcccc

SEQ ID NO: 191 - DNA, 46 bp, Artificial Sequence
  Fusion Primer B-MID43-D835R
gccttgccagcccgctcagtcgcactagtcagcctcacattgcccc

SEQ ID NO: 192 - DNA, 46 bp, Artificial Sequence
  Fusion Primer B-MID44-D835R
gccttgccagcccgctcagtctagcgactcagcctcacattgcccc

SEQ ID NO: 193 - DNA, 46 bp, Artificial Sequence
  Fusion Primer B-MID45-D835R
gccttgccagcccgctcagtctatactatcagcctcacattgcccc

SEQ ID NO: 194 - DNA, 46 bp, Artificial Sequence
  Fusion Primer B-MID46-D835R
gccttgccagcccgctcagtgacgtatgtcagcctcacattgcccc

SEQ ID NO: 195 - DNA, 46 bp, Artificial Sequence
  Fusion Primer B-MID47-D835R
gccttgccagcccgctcagtgtgagtagtcagcctcacattgcccc

SEQ ID NO: 196 - DNA, 46 bp, Artificial Sequence
  Fusion Primer B-MID48-D835R
gccttgccagcccgctcagacagtatatacagcctcacattgcccc

SEQ ID NO: 197 - DNA, 46 bp, Artificial Sequence
  Fusion Primer B-MID49-D835R
gccttgccagcccgctcagacgcgatcgacagcctcacattgcccc

SEQ ID NO: 198 - DNA, 46 bp, Artificial Sequence
  Fusion Primer B-MID50-D835R
gccttgccagcccgctcagactagcagtacagcctcacattgcccc

SEQ ID NO: 199 - DNA, 46 bp, Artificial Sequence
  Fusion Primer B-MID51-D835R
gccttgccagcccgctcagagctcacgtacagcctcacattgcccc

SEQ ID NO: 200 - DNA, 46 bp, Artificial Sequence
  Fusion Primer B-MID52-D835R
gccttgccagcccgctcagagtatacatacagcctcacattgcccc

SEQ ID NO: 201 - DNA, 10 bp, Artificial Sequence
  MID-1
acgagtgcgt

SEQ ID NO: 202 - DNA, 10 bp, Artificial Sequence
  MID-2
acgctcgaca

SEQ ID NO: 203 - DNA, 10 bp, Artificial Sequence
  MID-3
agacgcactc

SEQ ID NO: 204 - DNA, 10 bp, Artificial Sequence
  MID-4
agcactgtag

SEQ ID NO: 205 - DNA, 10 bp, Artificial Sequence
  MID-5
atcagacacg

SEQ ID NO: 206 - DNA, 10 bp, Artificial Sequence
  MID-6
atatcgcgag

SEQ ID NO: 207 - DNA, 10 bp, Artificial Sequence
  MID-7
cgtgtctcta

SEQ ID NO: 208 - DNA, 10 bp, Artificial Sequence
  MID-8
ctcgcgtgtc

SEQ ID NO: 209 - DNA, 10 bp, Artificial Sequence
  MID-10
tctctatgcg

SEQ ID NO: 210 - DNA, 10 bp, Artificial Sequence
  MID-11
tgatacgtct

SEQ ID NO: 211 - DNA, 10 bp, Artificial Sequence
  MID-13
catagtagtg

SEQ ID NO: 212 - DNA, 10 bp, Artificial Sequence
  MID-14
cgagagatac

SEQ ID NO: 213 - DNA, 10 bp, Artificial Sequence
  MID-15
atacgacgta

SEQ ID NO: 214 - DNA, 10 bp, Artificial Sequence
  MID-16
tcacgtacta

SEQ ID NO: 215 - DNA, 10 bp, Artificial Sequence
  MID-17
cgtctagtac

SEQ ID NO: 216 - DNA, 10 bp, Artificial Sequence
  MID-18
tctacgtagc

SEQ ID NO: 217 - DNA, 10 bp, Artificial Sequence
  MID-19
tgtactactc

SEQ ID NO: 218 - DNA, 10 bp, Artificial Sequence
  MID-20
acgactacag

SEQ ID NO: 219 - DNA, 10 bp, Artificial Sequence
  MID-21
cgtagactag

SEQ ID NO: 220 - DNA, 10 bp, Artificial Sequence
  MID-22
tacgagtatg

SEQ ID NO: 221 - DNA, 10 bp, Artificial Sequence
  MID-23
tactctcgtg

SEQ ID NO: 222 - DNA, 10 bp, Artificial Sequence
  MID-24
tagagacgag

SEQ ID NO: 223 - DNA, 10 bp, Artificial Sequence
  MID-25
tcgtcgctcg

SEQ ID NO: 224 - DNA, 10 bp, Artificial Sequence
  MID-26
acatacgcgt

SEQ ID NO: 225 - DNA, 10 bp, Artificial Sequence
  MID-27
acgcgagtat

SEQ ID NO: 226 - DNA, 10 bp, Artificial Sequence
  MID-28
actactatgt

SEQ ID NO: 227 - DNA, 10 bp, Artificial Sequence
  MID-29
actgtacagt

SEQ ID NO: 228 - DNA, 10 bp, Artificial Sequence
  MID-30
agactatact

SEQ ID NO: 229 - DNA, 10 bp, Artificial Sequence
  MID-31
agcgtcgtct

SEQ ID NO: 230 - DNA, 10 bp, Artificial Sequence
  MID-32
agtacgctat

SEQ ID NO: 231 - DNA, 10 bp, Artificial Sequence
  MID-33
atagagtact

SEQ ID NO: 232 - DNA, 10 bp, Artificial Sequence
  MID-34
cacgctacgt

SEQ ID NO: 233 - DNA, 10 bp, Artificial Sequence
  MID-35
cagtagacgt

SEQ ID NO: 234 - DNA, 10 bp, Artificial Sequence
  MID-36
cgacgtgact

SEQ ID NO: 235 - DNA, 10 bp, Artificial Sequence
  MID-37
tacacacact

SEQ ID NO: 236 - DNA, 10 bp, Artificial Sequence
  MID-38
tacacgtgat

SEQ ID NO: 237 - DNA, 10 bp, Artificial Sequence
  MID-39
tacagatcgt

SEQ ID NO: 238 - DNA, 10 bp, Artificial Sequence
  MID-40
tacacgtgat

SEQ ID NO: 239 - DNA, 10 bp, Artificial Sequence
  MID-41
tagtgtagat

SEQ ID NO: 240 - DNA, 10 bp, Artificial Sequence
  MID-42
tcgatcacgt

SEQ ID NO: 241 - DNA, 10 bp, Artificial Sequence
  MID-43
tcgcactagt

SEQ ID NO: 242 - DNA, 10 bp, Artificial Sequence
  MID-44
tctagcgact

SEQ ID NO: 243 - DNA, 10 bp, Artificial Sequence
  MID-45
tctatactat

SEQ ID NO: 244 - DNA, 10 bp, Artificial Sequence
  MID-46
tgacgtatgt

SEQ ID NO: 245 - DNA, 10 bp, Artificial Sequence
  MID-47
tgtgagtagt

SEQ ID NO: 246 - DNA, 10 bp, Artificial Sequence
  MID-48
acagtatata

SEQ ID NO: 247 - DNA, 10 bp, Artificial Sequence
  MID-49
acgcgatcga

SEQ ID NO: 248 - DNA, 10 bp, Artificial Sequence
  MID-50
actagcagta

SEQ ID NO: 249 - DNA, 10 bp, Artificial Sequence
  MID-51
agctcacgta

SEQ ID NO: 250 - DNA, 10 bp, Artificial Sequence
  MID-52
agtatacata

(19) United States
(12) Patent Application Publication
(10) Pub. No.: US 2012/0259656 A1
(43) Pub. Date: Oct. 11, 2012

(54) MANAGING BIOMARKERS AND ASSOCIATED LICENSES

(75) Inventors: Jeffrey E. Miller, San Diego, CA (US); Andrew Ross Cubbon, San Diego, CA (US)

(73) Assignee: INVIVOSCRIBE TECHNOLOGIES, INC., San Diego, CA (US)

(21) Appl. No.: 13/441,801

(22) Filed: Apr. 6, 2012

Related U.S. Application Data
(60) Provisional application No. 61/473,716, filed on Apr. 8, 2011.

(51) Int. Cl. G06Q 50/22

(52) U.S. Cl. 705/2

(57) ABSTRACT

Systems and method for the management of biomarkers or biomarker associations subject to restricted access, such as by licensing fees, are provided. A license manager maintains license fee information on a number of biomarkers or biomarker associations. In one embodiment, a user may submit biological data for testing against one or more of the maintained biomarkers. The license manager determines which positive test results require use of licensed biomarkers or biomarker associations and may present this information to the user. In another embodiment, a set of biomarkers or biomarker associations may be submitted to determine if any biomarkers subject to license are included. The licensing manager determines whether licenses exist for included biomarkers and may return specific licensing information.

### RELATED APPLICATION

The present application claims the benefit of priority to U.S. Provisional Patent Application No. 61/473,716, filed Apr. 8, 2011, the entire disclosure of which is incorporated herein by reference in its entirety.

### REFERENCE TO SEQUENCE LISTING

This application incorporates by reference the sequence listing submitted as ASCII text filed via EFS-Web on Apr. 6, 2012. The Sequence Listing is provided as a file entitled “IVSC.027A Sequence Listing”, created on Apr. 6, 2012 and which is approximately 44.9 kilobytes.

### BACKGROUND

Traditionally, diagnosis of disease has relied on morphological examination and symptom presentation. However, under this approach, no diagnosis occurs until the disease has progressed to the point of physical manifestation. For many diseases, early detection can lead to early treatment, which, in turn, can significantly improve recovery and survival rates. Further, detection of a susceptibility to a disease prior to the appearance of symptoms can enable changes in lifestyle, which can minimize severity or even prevent the disease from ever manifesting. Thus, over the past several years, there has been considerable interest in the role of biological markers in the prevention, early detection, diagnosis and treatment of disease.

Generally described, a biomarker is any substance or characteristic, which may be objectively measured and used as an indicator of a biological state, normal biologic processes, pathogenic processes or pharmacologic responses to a therapeutic intervention. One example of a biomarker a pathogenic process is the presence of characterized mutations in the fms-related tyrosine kinase 3 (FLT3) gene. FLT3 mutations are one of the most frequent somatic alterations in acute myeloid leukemia (AML), occurring in approximately ¼ of patients. The presence of a FLT3 mutation is indicative of poor prognosis.

While FLT3 mutation is an instance where detection of a single biomarker is indicative of a disease state, given the complex interaction of human biochemistry, the interaction of multiple markers often has a bearing on the presence or absence of disease, disease predisposition, or response to therapeutic intervention. In most cases, it is the constellation of biomarkers that acts as an overall indicator of present and future biological states, normal biologic processes, pathogenic processes, or pharmacologic responses to a therapeutic intervention. Further, inter-relationships between biomarkers are such that the relevance or impact of one detected biomarker might be altered based on the presence or status of one or more other biomarkers.

In some cases, biomarkers are subject to restricted use by various rights holders. For example, a particular biomarker or use of that biomarker may be subject to intellectual property rights, such as patent rights. Utilization of these restricted use biomarkers may require permission of the relevant rights holders, which often further requires payment of a licensing fee or royalty. However, mere identification of the rights holder can prove difficult for a practitioner who wants to utilize biomarker analysis. This is further complicated in cases where multiple biomarkers together indicate a biological state. Often, these multiple biomarkers are subject to different rights or different rights holders, complicating their use. These issues can discourage the use and development of biomarkers.

As problematic or more problematic for the physician, and impacting in a very real sense the care of patients, is the difficulty in staying current with information on the clinical efficacy of biomarkers and how all of the information around the ever increasing number of individual biomarkers, coupled with other biological or data inputs and various additional lifestyle metrics together are likely to impact the patient, both in risk assessment and disease intervention and treatment.

### BRIEF DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a block diagram depicting an illustrative environment for managing licensed biomarkers, the environment including a number of computing devices, a number of laboratories, a biological processing server, a biomarker data store, diagnosis and treatment information processing server, diagnosis and treatment information data store, and a license and payment server;

FIGS. 2A and 2B are block diagrams of the illustrative licensed biomarker management environment of FIG. 1 depicting the analysis of biological data for determination of licensed biomarkers and payment of associated license fees;

FIG. 3 is a block diagram of the illustrative licensed biomarker management environment of FIG. 1 depicting the analysis of a biomarker data set for determination of licensed biomarkers and associated fees;

FIG. 4 is a flow diagram depicting an illustrative license fee determination routine implemented by the license fee and payment server shown in FIG. 1;

FIG. 5 is an illustrative user interface displaying a submission form for use in submitting biological data to the biological data processing server shown in FIG. 1;

FIGS. 6A and 6B are illustrative user interfaces displaying a summary of biomarker analysis results and corresponding license information;

FIG. 7 is an illustrative user interface displaying a detailed biomarker analysis result;

FIG. 8 is an illustrative user interface displaying a submission form for use in submitting a biomarker data set to a license and payment processing server; and

FIG. 9 is an illustrative user interface displaying license information associated with biomarkers in a biomarker data set.

### DETAILED DESCRIPTION

The embodiments described herein relate to systems and methods for managing biomarkers, relationships between biomarkers, biomarker datasets and biological data, and the identification and payment of licensing fees to rights holders. The methods and systems described herein promote the use and development of biomarkers and biomarker dataset relationships by simplifying the identification and compensation of rights holders by practitioners. Such systems and methods may benefit all stakeholders.

This is becoming more important as affordable whole genome sequencing becomes a reality. Now, as opposed to targeted detection using monoclonal antibodies, PCR, or hybridization assays, it is possible to sequence an individual's entire genome, or relevant portions thereof, and simply detect, for example, the presence or absence of a sequence of interest within that data set. Alternatively, one can sequence potentially mutated cells (such as cancer cells, including lymphoid cancers and solid tumors) to ascertain whether certain mutations are present. Although the patient or care provider may be in possession of up to an entire genome sequence, the detection of biomarkers of importance within that sequence may implicate intellectual property rights of many different parties with many different licensing policies, making it difficult or impossible for individuals to navigate the complex intellectual property landscape, and difficult or impossible for intellectual property owners to collect applicable usage royalties. Hence, disclosed herein is a system, apparatus, and method for aggregating intellectual property rights under a single, simplified licensing and content delivery system that facilitates compliance with intellectual property rights and provides legal, curated results to end users.

In the description that follows, a number of terms are used extensively:

As described herein, a biomarker is any substance that may be objectively measured and used as an indicator of a physiological state or likelihood of change of that physiological state. The physiological state may be a normal biologic processes, pathogenic processes, response to exercise, response to a pharmacologic or response to other therapeutic intervention. Examples of a biomarker include, but are not restricted to, DNA, RNA, proteins, peptides, carbohydrates, lipids, or fragments thereof, metabolites, and other small molecules. Examples of nucleic acids-based biomarkers include, but are not limited to, gene mutations, polymorphisms and quantitative gene expression analysis. In some embodiments, metabolic products may serve as biomarkers. In some embodiments, antigens and antibodies may serve as biomarkers. In several embodiments, a nucleotide polymorphism may serve as a biomarker. In some embodiments, the detected level of a protein may serve as a biomarker. The term “licensed biomarker” refers to any biomarker subject to restricted use by a rights holder.

A “biomarker data set” is an electronic or data representation of biological data from a biological sample or from a patient or individual. In one exemplary embodiment, it comprises a DNA sequence, a RNA sequence, a protein or peptide sequence, exome, transcriptome, antibody (including autoantibody) profile, metabolome, epigenome, proteome or one or more measured biometric values from a patient. The biomarker data set could be represented by one, two, or three-dimensional images or points, or information of any derived from any of the techniques employed to analyze biological systems, but in most instances, it will comprise data in a computer or storage medium, or data being transmitted in any manner, whether in electronic, optical, sonic, electromagnetic, wave-form, or any other form.

As used herein, “nucleic acid” or “nucleic acid molecule” refers to polynucleotides, such as deoxyribonucleic acid (DNA) or ribonucleic acid (RNA), oligonucleotides, fragments generated by the polymerase chain reaction (PCR), and fragments generated by any of ligation, scission, endonuclease action, and exonuclease action. Nucleic acid molecules can be composed of monomers that are naturally-occurring nucleotides (such as DNA and RNA), or analogs of naturally-occurring nucleotides (e.g., enantiomeric forms of naturally-occurring nucleotides), or a combination of both. Nucleic acids can be either single stranded or double stranded.

An “isolated nucleic acid molecule” is a nucleic acid molecule that is not integrated in the genomic DNA of an organism. For example, a DNA molecule that encodes a growth factor that has been separated from the genomic DNA of a cell is an isolated DNA molecule. Another example of an isolated nucleic acid molecule is a chemically-synthesized nucleic acid molecule that is not integrated in the genome of an organism. A nucleic acid molecule that has been isolated from a particular species is smaller than the complete DNA molecule of a chromosome from that species.

“Complementary DNA (cDNA)” is a single-stranded DNA molecule that is formed from an mRNA template by the enzyme reverse transcriptase. Typically, a primer complementary to portions of mRNA is employed for the initiation of reverse transcription. Those skilled in the art also use the term “cDNA” to refer to a double-stranded DNA molecule consisting of such a single-stranded DNA molecule and its complementary DNA strand. The term “cDNA” also refers to a clone of a cDNA molecule synthesized from an RNA template.

A “polypeptide” is a polymer of amino acid residues joined by peptide bonds, whether produced naturally or synthetically. Polypeptides of less than about 10 amino acid residues are commonly referred to as “peptides.”

A “protein” is a macromolecule comprising one or more polypeptide chains. A protein may also comprise non-peptide components, such as carbohydrate groups. Carbohydrates and other non-peptide substituents may be added to a protein by the cell in which the protein is produced, and will vary with the type of cell. Proteins are referred to herein in terms of their amino acid backbone structures; substituents such as carbohydrate groups are generally not specified, but may be present nonetheless.

As used herein, the terms “patient” and “subject” refer to a biological system from which a biological sample or biological data can be collected or to which a therapeutic agent can be administered. A patient can refer to a human patient or a non-human patient. Patients can include those that are healthy and those having a disease, such as cancer. Patients having a disease can include patients that have been diagnosed with the disease, patients that exhibit a set of symptoms associated with the disease, and patients that are progressing towards or are at risk of developing the disease.

As used herein, the term “biological sample” refers to a biological material that can be collected from a patient and used in connection with diagnosis or monitoring of biological states. Biological samples can include clinical samples, including body fluid samples, such as body cavity fluids, urinary fluids, cerebrospinal fluids, blood, and other liquid samples of biological origin; and tissue samples, such as biopsy samples, primary tumor samples, and other solid samples of biological origin. Biological samples can also include those that are manipulated in some way after their collection, such as by treatment with reagents, culturing, solubilization, enrichment for certain biological constituents, cultures or cells derived therefrom, and the progeny thereof.

As used herein, the term “biological state” refers to a condition associated with a patient or associated with a biological sample collected from the patient. A biological state can refer to a healthy state, which corresponds to a normal condition in the substantial absence of a disease, or a disease state, which corresponds to an abnormal or harmful condition associated with a disease.

As used herein, the terms “biological data” and “biological sample data” refer to any information associated with a patient or associated with a biological sample collected from the patient. Biological data can include whole or partial genome sequence, exome, transcriptome, antibody (including autoantibody) profile; metabolome; epigenome; and proteome data. Biological data can also include gender; age; weight; geographic location; family history; personal history; race and ethnicity; drug use (therapeutic and recreational); alcohol use; tobacco use; physical activity; diet; blood pressure, heart rate, metabolite levels, blood sugar levels, blood oxygen saturation levels, cholesterol level and other biometric or physiological data.

The term “user” as used herein is not limited and may be any person or entity that interacts with the licensed biomarker management environment. Examples of users include, but are not limited to, patients corresponding to the biological samples or biological data, health care providers, researchers, health care organizations, research organizations, laboratories, biomarker rights holders, pharmaceutical companies and corporations, intermediary service providers, biologics companies and corporations, universities, licensees, etc.

Generally described, the present disclosure is directed to managing biomarkers subject to restricted use. Specifically, aspects of the disclosure will be described with regard to the management and processing of biomarker data sets, biological data that contain biomarkers, and other biological data. Although various aspects of the disclosure will be described with regard to illustrative examples and embodiments, one skilled in the art will appreciate that the disclosed embodiments and examples should not be construed as limiting.

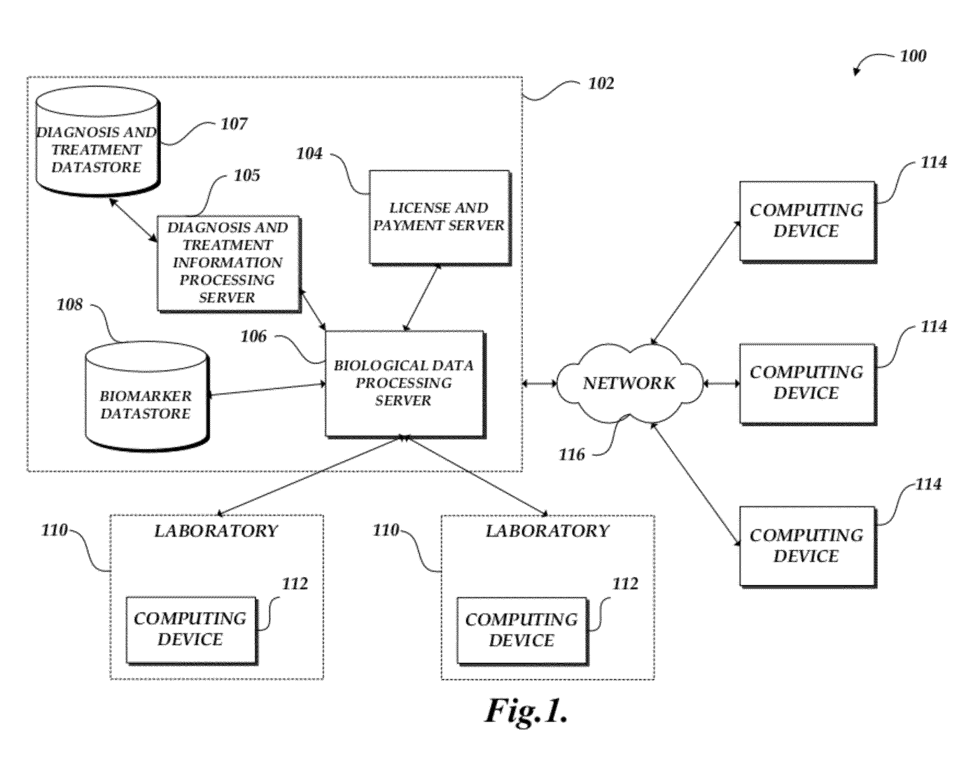

FIG. 1 is a block diagram illustrative of a licensed biomarker management environment 100 for analyzing biomarker data sets, biological data containing biomarkers, and other biological data. As illustrated in FIG. 1, the licensed biomarker management environment 100 includes a number of computing devices 114 utilized by clients of the licensed biomarker management system, a number of laboratories 110 (having one or more computing devices 112), a biological processing server 106, a biomarker data store 108, diagnosis and treatment information processing server 105, a diagnosis and treatment information data store 107 and a license and payment server 104. In an illustrative environment, the computing devices 112 and 114 can correspond to a wide variety of computing devices including personal computing devices, laptop computing devices, hand-held computing devices, terminal computing devices, mobile devices, wireless devices, various electronic devices and appliances, and the like. In an illustrative embodiment, the client computing devices 112 and 114 include necessary hardware and software components for establishing communications over a wired and/or wireless network 116, such as a wide area network or local area network. For example, the client computing devices 112 and 114 may be equipped with networking equipment and browser software applications that facilitate communications via the Internet or an intranet.

The licensed biomarker management environment 100 can also include a license management provider 102 in communication with the one or more computing devices 114 via the network 116. The license management provider illustrated in FIG. 1 corresponds to a logical and/or physical association of one or more computing devices associated with a license management provider. Specifically, the license management provider 102 can include a biological data processing server 106 for analyzing biological data to determine the existence of corresponding biomarkers. Such biological data may be obtained from computing devices 114 via the network 116, or may be obtained from one or more computing devices 112 at one or more laboratories, data centers, or other storage or service centers, such as laboratories 110. In some embodiments, a user or data repository or data generator (e.g., a whole genome sequencing facility) may submit biological data to the biological data processing server 106 via a web interface presented by a computing device 114, or may physically send the biological data in the form of a hard disk, flash memory, optical storage medium, or the like. In other embodiments, a biological sample may be submitted to a laboratory 110, which would then be analyzed to create biological data. The laboratory 110 would then submit the biological data from a computing device 112 to the biological data processing server 106. In some embodiments, a computing device 114, such as a wearable computing device or a wholly or partially implantable computing device, can be configured to monitor one or physiological parameters, such as blood pressure, heart rate, metabolite levels, blood sugar levels, blood oxygen levels, cholesterol levels, body temperature, respiration rate, hormone levels, antibody profile, histamine, protein levels, etc. One skilled in the art will appreciate that such submission of biological data may occur by a variety of means, including but not limited to, utilizing a computing device 112 or 114 (or other computing device) to submit biological data via a network or physical submission of biological data by, for example, hard disk, flash memory, optical storage medium, or the like.

The license management provider 102 can further include a biomarker data store 108 in communication with the biological processing server for storing information regarding individual biomarkers or groups of biomarkers. The biological data processing server may utilize biomarker information stored within biomarker data store 108 to identify corresponding biomarkers in submitted biological data.

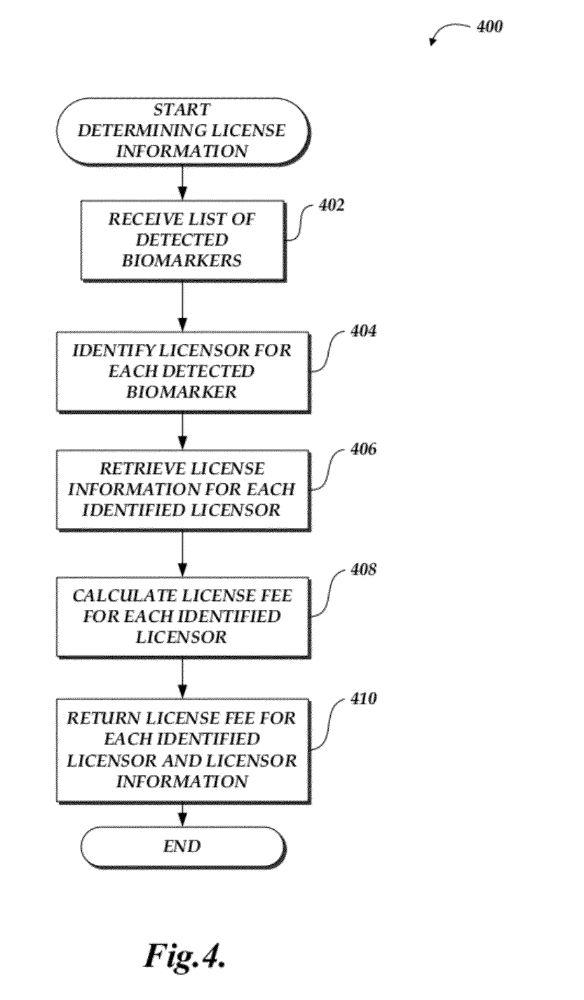

Additionally, the license management provider 102 can include a license and payment server 104 in communication with the biological processing server. The license and payment server may utilize biomarker information to determine licensing information associated with those biomarkers. In some embodiments, the biomarker information utilized may be received from the biological data processing server 106, such as where specific biological data is processed to determine existence of one or more biomarkers in the biological data. In other embodiments, the license and payment server 104 may receive biomarker information from other sources, such as from computing devices 114 over a communications network 116. The license and payment server 104 may then determine licensing information for biomarkers described within the received biomarker information. This determination process is further described with respect to FIG. 4, below.

In some embodiments, the license management provider 102 may further include a data store (not shown) for storing submitted biological data or information the biological data for future use. For example, the license management provider 102 may enable a customer to submit biological data, for example a genome sequence, exome sequence, metabolome, proteome, etc., for future testing in addition to or exclusive of current testing. In some embodiments, the license management provider 102 may enable a user to create an account and associate submitted biological data with the account. The account may further be associated with additional user information (e.g., payment information, personal information, health care provider contact information, etc.). As such, though illustrative embodiments are described herein with respect to submission and analysis of biological data, in some embodiments, previously submitted biological data may be utilized for analysis.

In some embodiments, the license management provider 102 can include a diagnosis and treatment information processing server 105 in communication with the biological data processing server 106. The diagnosis and treatment information processing server 105 may utilize biomarker data information to identify diagnosis and treatment recommendations; perform molecular risk assessments; calculate statistical correlations; identify predictive, diagnostic, prognostic, staging and pharmacodynamic biomarkers and generate other relevant information associated with a biomarker data set or biomarker data sets. In some embodiments, the diagnosis and treatment information processing server 105 may utilize biomarker data information in combination with other biological data information to identify diagnosis and treatment recommendations; perform molecular risk assessments; calculate statistical correlations; identify predictive, diagnostic, prognostic, staging and pharmacodynamic biomarkers; monitor physiologic condition; calculate heath status; determine need for medical intervention and generate other relevant information associated with the biological data profile. In some embodiments, the biomarker data information and/or other biological data information may be received from the biological data processing server 106, such as where biological data is processed to determine existence of one or more biomarkers in the biological data. In other embodiments, the diagnosis and treatment information processing server 105 may receive biomarker data information and/or other biological data information from other sources, such as from computing devices 114 over a communications network 116. The diagnosis and treatment information processing server 105 may then identify diagnosis and treatment recommendations; perform molecular risk assessments; monitor physiologic condition; calculate heath status; determine need for medical intervention and generate other relevant information based on the biomarkers described and/or other biological data information within the received biological data set to generate a customized diagnosis and treatment report.

The license management provider 102 can further include a diagnosis and treatment information data store 107 in communication with the diagnosis and treatment information processing server 105 for storing information regarding diagnosis and treatment recommendations, biomarker data set information, biological data set information (biomarker data set information and other biological data set information), and other relevant information associated with the presence of individual biomarkers, groups of biomarkers and/or other biological data information. The diagnosis and treatment information processing server 105 may utilize diagnosis and treatment recommendation information stored within treatment information data store 107 to identify corresponding diagnosis and treatment recommendation information in submitted biomarker information and/or other biological data information.

Following analysis of the biological data for the presence of one or more of the applicable subset of biomarkers, a list of biomarkers detected in the biological data (biomarker data information) and/or other biological data information can be transmitted to the diagnosis and treatment information processing server 105. A list of biomarkers detected in the biological data (biomarker data information) and/or other biological data information can be transmitted to the diagnosis and treatment information processing server 105 prior to, simultaneous with or after processing and confirmation of payment information. In one embodiment, a list of biomarkers detected in the biological data (biomarker data information) and/or other biological data information can be transmitted to the diagnosis and treatment information processing server 105 after the license and payment server 104 processes the submitted payment information and confirms payment to the biological data processing server 106. The diagnosis and treatment information processing server 105 can utilize the detected biomarker information and/or other biological data information to determine a molecular risk assessment, customized diagnosis and treatment recommendations and other relevant information applicable to the detected biomarkers. The diagnosis and treatment information processing server 105 may apply data on effectiveness of a biomarker or set of biomarkers for the diagnosis, prognosis, and risk assessment for a particular physiological condition generated in independent studies and/or by analysis of biological information data sets to determine a molecular risk assessment, customized diagnosis and treatment recommendations, or other relevant information applicable to the detected biomarker data information. Customized diagnosis and treatment recommendations may correspond, for example, with prognosis information; with disease diagnosis information; with disease staging information; with molecular risk assessment information; with pharmaceutical treatment information; with response to clinical intervention; with recommendation of additional biomarker test information; with specialist referral information; with support group referral information; with clinical study participation information; with dietary treatment information or with other diagnosis and treatment recommendations information.

After diagnosis and treatment recommendation information applicable to the detected biomarkers have been determined and formatted, this information can be returned to the biological data processing server 106 which formats detailed results. Utilizing the diagnosis and treatment recommendations information, the biological data processing server 106 can provide a customized diagnosis and treatment recommendation report to the computing device 114 after license agreement and fee payment are received. In some embodiments, the customized diagnosis and treatment recommendation may correspond to a description of the biomarkers detected and the disease, condition or other physiological state to which the biomarkers are linked. In some embodiments, the customized diagnosis and treatment recommendation information may correspond to an assessment of the probability of having had developed or developing a particular disease associated with the detected biomarkers and/or other biological data information. In other embodiments, the summary of customized diagnosis and treatment recommendation information may correspond to pharmaceutical treatment and dosing information. In some embodiments, upon receipt of license agreement and payment, the diagnosis and treatment recommendations information and payment confirmation is provided to the user of the client computing device 114. In some embodiments, a summary of detected biomarkers is provided such that the user of the client computing device 114 may select one or more of the detected biomarkers and submit payment information corresponding to the required licensing fees to receive further diagnosis and treatment recommendation information regarding the selected biomarkers. In some embodiments, the payment confirmation and diagnosis and treatment recommendation information is provided such that the user of the client computing device 114 may select one or more additional assays, biomarkers or sets of biomarkers recommended for further analysis of the biological data based on the profile of the analyzed biomarker(s) by selecting a corresponding checkbox and submitting the selection by use of submission button 610. In some embodiments, this may require submission of payment information corresponding to the required licensing fees. Alternatively, the user may select to not undertake further analysis by selecting cancellation button.

Following receipt of the detected biomarker data information and/or other biological data information, the diagnosis and treatment information processing server 105 can determine or apply appropriate statistical calculations with which to analyze correlations between the biomarker data information and likelihood of having had developed or developing a disease or condition; responding to a particular treatment regime; or having a particular physiological state. Such determination may be made, for example, based on a statistically weighted combination of biomarker data information and other biological data information. The applicable subset or subsets of diagnosis and treatment recommendation information may correspond to a specifically detected biomarker, to specifically detected groups or subgroups of biomarkers, to combinations of specifically detected biomarkers and other biological data information, to a designated range of confidence intervals for a correlation, or to any other selection criteria. The diagnosis and treatment information processing server 105 then requests the applicable subsets of diagnosis and treatment information from the diagnosis and treatment information datastore 107, which are then returned to the diagnosis and treatment information processing server by the datastore. The diagnosis and treatment information processing server 105 then formats the diagnosis and treatment information and provides the diagnosis and treatment information to the biological data processing server 106. As will be appreciated by one skilled in the art, the returned diagnosis and treatment information may, in various embodiments, correspond to general information, a customized diagnosis and treatment report, a report that a correlation with a disease or condition was detected without disclosing the disease or condition or other diagnosis and treatment information.

In some embodiments, following receipt of the detected biomarker data information and/or other biological data information, the diagnosis and treatment information processing server 105 can retrieve biological information data sets or biomarker information data sets from the diagnosis and treatment information datastore 107 to determine or apply appropriate statistical calculations with which to analyze the detected biomarker information and/or other biological data information in comparison to other biological information data sets retrieved from the diagnosis and treatment information datastore. The diagnosis and treatment information processing server 105 compares biological information data sets and applies statistical analysis to identify statistically significant correlations between individual biomarkers, groups and subgroups of biomarkers, other biological characteristics (for example, gender, age, race and ethnicity, weight, activity levels, drug use, medical history, family history, etc.), or any combination thereof and a physiological state. Based on statistically significant correlations, the diagnosis and treatment information processing server 105 can perform molecular risk assessments; identify predictive, diagnostic, prognostic, staging and pharmacodynamic biomarkers and generate other correlative data. The diagnosis and treatment information processing server 105 may also apply parameters for sensitivity (e.g. >=0.9) and/or specificity (e.g. >=0.9). The diagnosis and treatment information processing server 105 may apply statistical analysis to identify individual biomarkers, groups and subgroups of biomarkers with positive predictive value or negative predictive value for a particular physiological state, for example response to a pharmaceutical treatment regime. The results of the statistical analysis undertaken by the diagnosis and treatment information processing server 105 are formatted and this information can be returned to the biological data processing server 106 which formats detailed results. Upon receipt of license agreement and payment, the diagnosis and the detailed results and payment confirmation is provided to the user of the client computing device 114. In some embodiments, detailed results on the statistical analysis of a biomarker are provided to the rights holder.

In some embodiments, the diagnosis and treatment information processing server 105 may submit the detected biomarker information and/or other biological data information received from the biological data processing server 106 to the diagnosis and treatment information datastore 107. In some embodiments, the biological data processing server 106 may submit biomarker data information and/or other biological data information directly to the diagnosis and treatment information datastore 107 (interaction not shown).

Though identifying diagnosis and treatment recommendation information for the biomarker data set is discussed with regard to the diagnosis and treatment information processing server 105, one skilled in the art will appreciate that in some embodiments the biological data processing server 106 can perform this function.

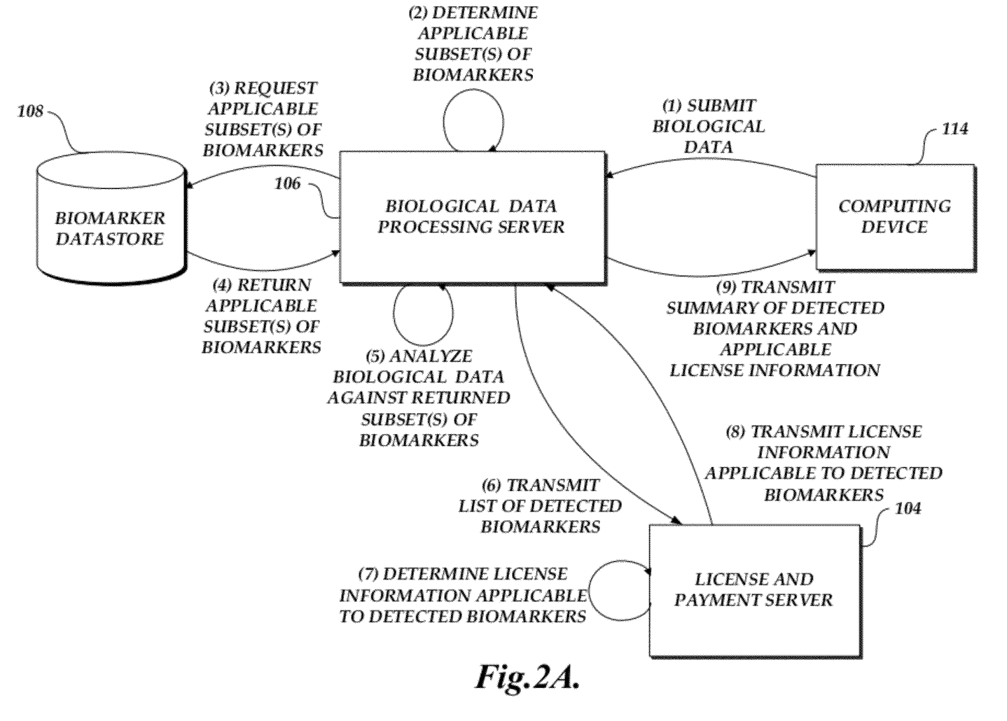

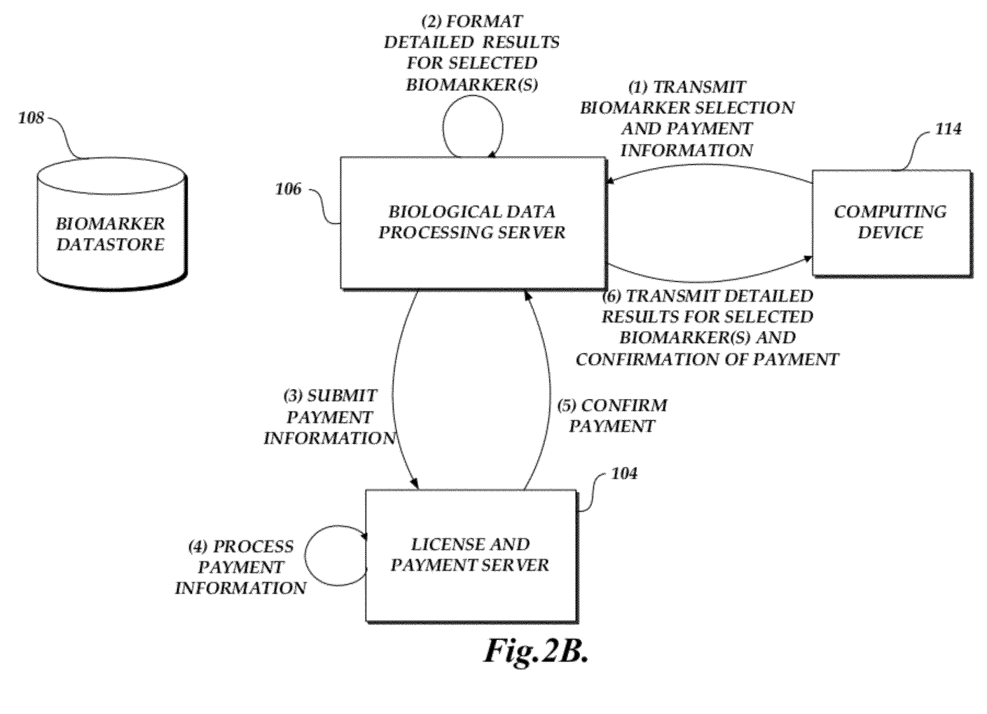

With reference to FIG. 2A, an illustrative interaction for management of licensed biomarkers with biological data will be described. As illustrated in FIG. 2A, the computing device 114 can submit biological data to the biological data processing server 106. In some embodiments, such submission may further include agreement on the part of the user of the computing device 114 to comply with terms of submission. Such terms of submission may, by way of non-limiting example, correspond to agreement to pay fees associated with analysis, regardless of analysis results, or with additional licensing terms associated with biomarker analysis. Such licensing terms may include provisions that new biomarkers detected during analysis of the biological data are the intellectual property of the operator of the license and payment server, the rights holder of the licensed biomarker or biomarkers, or another entity. In one embodiment, the user, such as a patient or care provider, may agree to a license agreement directly with the entity that owns or controls the intellectual property rights in the analysis or detection of the biomarkers, providing direct privity of contract with that user, rather than entering into a licensed transaction with an intermediary (the entity that compares the biomarker datastore with the licensed biological data). In another embodiment, the service provider or intermediary holds a license from the intellectual property owners, and provides a sublicense, an implied license, or no license to the user. One skilled in the art will appreciate that licenses granted to users may be temporary or limited in nature. For example, such a license may only allow analysis of only a limited number of biological samples, sharing of the analysis results with specified parties, or may otherwise expire based on other criteria. Though illustrative terms are discussed herein (e.g., payment of a fee), licenses may include additional or alternative terms without departing from the scope of this disclosure.

In some embodiments, the license management provider 102 may act to negotiate licenses between one or both of the submitting user (as licensee) and the rights holder (as licensor). Negotiation of such licenses may include, for example, consideration of the size of each entity (e.g., income level, number of employees, etc.), status of each entity (e.g., individual or legal entity, for-profit, non-profit, or educational entity), or other criteria. In some embodiments, licenses may be sought for a collection of intellectual property rights (e.g., one or more patents, trade secrets, etc.). As such, negotiation of licenses may include consideration of the collection of rights sought to be licensed.

In other embodiments, the license management provider 102 may act as an intermediary that holds a license from one or more rights holder, and that offers sublicenses to users. Sublicenses granted to users may include additional or alternative terms than licenses held by the license management provider 102 (or an operator thereof). For example, in some embodiments, the license management provider 102 may provide sublicenses to intellectual property rights at a lower cost than specified in the original license (e.g. for advertising or marketing purposes), or may provide combinations of sublicenses for fixed costs independent of the cost paid for the initial license by the license management provider 102. One skilled in the art will appreciate that terms of sublicenses may include any of the considerations discussed above with respect to licenses, as well as alternative or additional considerations.

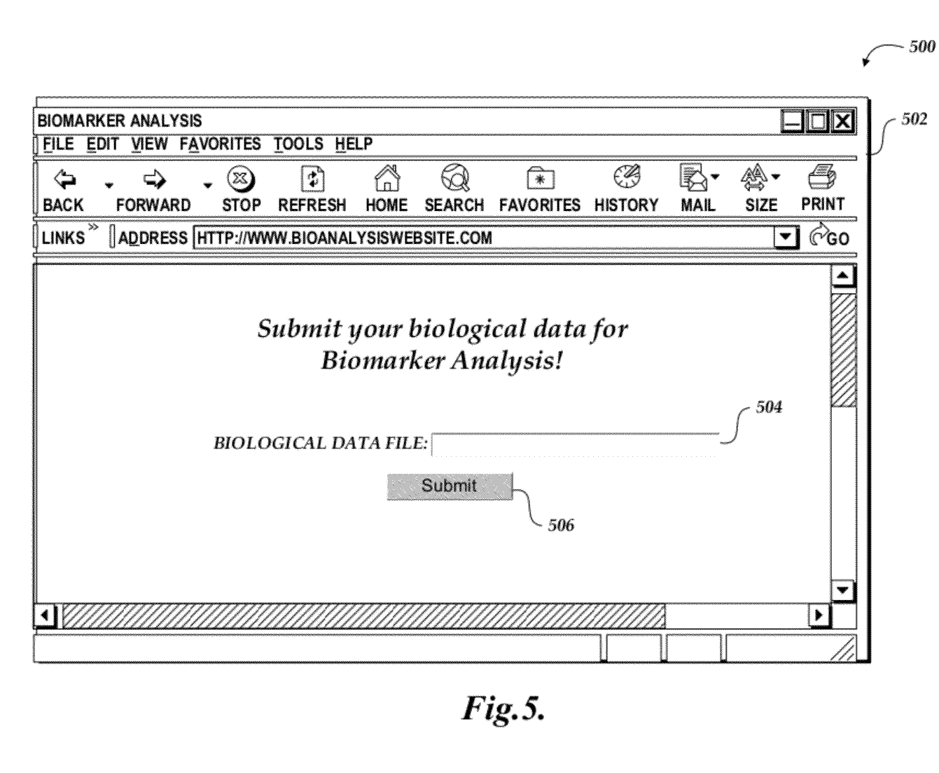

One example of a user interface for such biological data submission is shown in FIG. 5 by web or other network based user interface 500. As shown in FIG. 5, interface window 502 allows a user to input a location or identifier (e.g., a file name, address, user name, etc.) associated with a biomarker biological data in input box 504. The computing device 114 may then submit the biological data to the biological data processing server 106 by user selection of the submit button 506. Alternatively, where a party other than the user has possession of or access to the biological data, the user may request or authorize access to or analysis of the biological data through the interface window 502. This can be used, for example, where the analysis is performed in conjunction with and optionally by an entity that also performs DNA sequencing for the user, or where the sequencing entity separately provides the sequence data to the entity performing the analysis (e.g., separately provides the biological data to the biomarker datastore 108).

Following receipt of the biological data, the biological data processing server 106 can determine or apply an applicable subset or subsets of biomarkers with which to analyze the biological data. Such determination may be made, for example, based on information provided by the computing device 114. The applicable subset or subsets of biomarkers may correspond to specifically selected biomarkers, to biomarkers associated with certain diseases, to biomarkers having certain licensing characteristics, or to any other selection of biomarker subsets. The biological data processing server 106 then requests the applicable subsets of biomarkers from the biomarker datastore 108, which are then returned to the biological data processing server 106 by the datastore 108. As will be appreciated by one skilled in the art, the returned biomarkers may, in various embodiments, correspond to biomarker data or other biomarker information that facilitates analysis of biological data for the applicable subset of biomarkers.

With continued reference to FIG. 2A, following return of the applicable subset of biomarkers to the biological data processing server 106, the biological data processing server 106 can analyze the biological data to detect the presence of one or more of the applicable subset of biomarkers. One example of such analysis will be discussed below with respect to EXAMPLE 1. One skilled in the art will appreciate that the example discussed in EXAMPLE 1 is a non-limiting example of one of many ways in which such biomarker analysis may be performed. Following analysis of the biological data for the presence of one or more of the applicable subset of biomarkers, a list of biomarkers detected in the biological data can be transmitted to the license and payment server 104. The license and payment server 104 can utilize the detected biomarker information to determine corresponding licensing information applicable to the detected biomarkers. Such licensing information may correspond, for example, with applicable licensors of any of the detected biomarkers, with licensing fees applicable to the detected biomarkers, with terms of licenses associated with the detected biomarkers, or to other licensing information. One embodiment of such a determination routine will be discussed with reference to FIG. 4 below.

With continued reference to FIG. 2A, after licensing information applicable to the detected biomarkers has been determined, this information can be returned to the biological data processing server 106. Utilizing the licensing information, the biological data processing server 106 can provide a summary of detected biomarkers and applicable licensing information to the computing device 114. In some embodiments, the summary of detected biomarkers may correspond to a basic list of which biomarkers have been detected. In other embodiments, the summary of detected biomarkers may correspond to information that biomarkers associated with certain diseases have been detected, with or without disclosing the exact biomarkers. In still more embodiments, the summary of detected biomarkers may disclose only that a number of biomarkers have been detected. The applicable licensing information may, as described above, correspond to licensing fees, identities of licensors, license terms, or other information. The combined licensing information and summary of detected biomarkers is provided such that the user of the client computing device 114 may select one or more of the detected biomarkers and receive further information regarding those biomarkers.

In another embodiment, the user selects particular assays or biomarkers or sets of biomarkers and pays prior to performance of the analysis or prior to identification of the results (detected biomarkers). In this instance, the royalty model may provide for payment of a royalty, regardless of whether the result of the analysis is positive (biomarker present) or negative (biomarker absent).

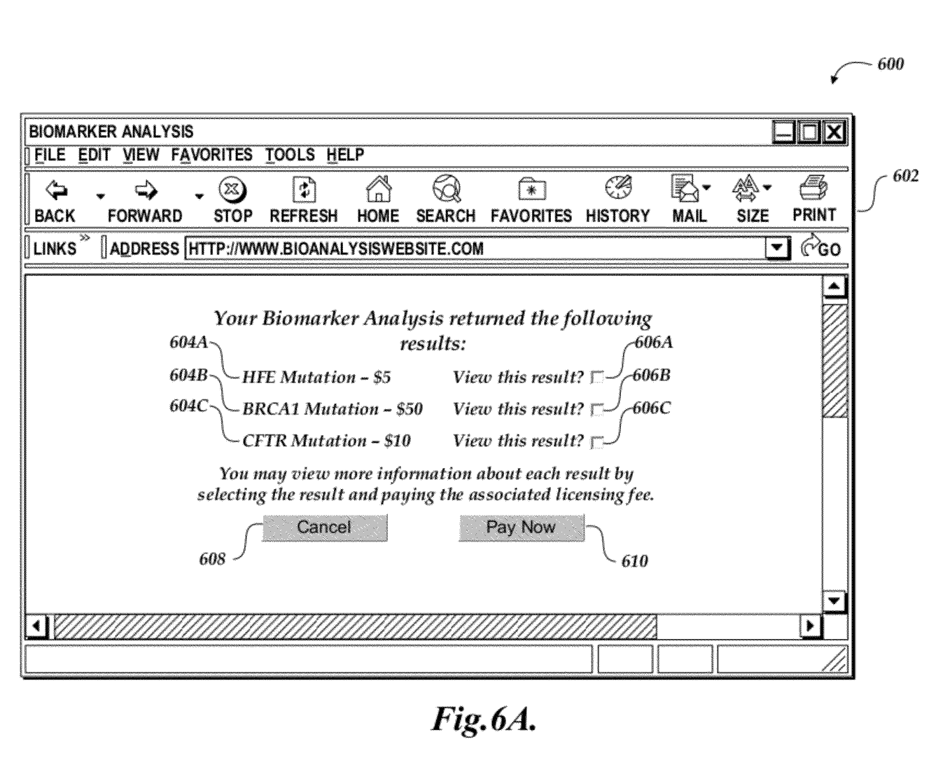

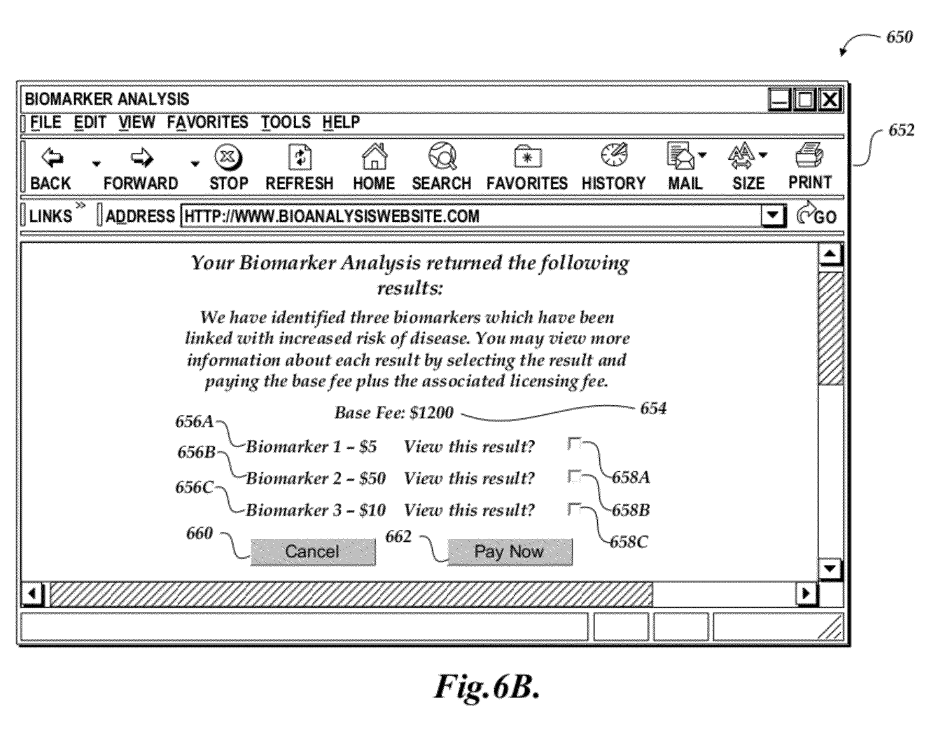

One example of a web-based user interface for such selection of detected biomarkers is user interface 600 shown in FIG. 6A. Interface window 602 provides a user of a computing device, such as computing device 114 shown in FIG. 1, with a number of detected biomarkers 604A-C. In this example, the name of the detected biomarker is given, along with the applicable licensing fee for each biomarker. The user may select one or more of the detected biomarkers by selecting a corresponding checkbox 606A-C, and submit the selection by use of submission button 610. In some embodiments, this may require submission of payment information corresponding to the required licensing fees. Alternatively, the user can have an account that preauthorizes charges for any biomarkers later detected and/or selected, or the user can prepay for the services using a flat fee, not necessarily dependent on which or how many biomarkers are ultimately detected or reported. In such a case, the license and payment server can authorize or validate the transaction on the basis of the prepayment or payment authorization already in place. Methods of submitting any such payment information via web interfaces will be familiar to those of skilled in the art. Alternatively, the user may select to view none of the mutations by selecting cancellation button 608. In some embodiments, the user may still be required to pay for the initial analysis service, even where detailed information is not requested.

A second example of a web-based user interface for selection of detected biomarkers is user interface 650 shown in FIG. 6B. Similar to FIG. 6A, interface window 652 provides the user of a computing device 114 with a number of detected biomarkers 656A-C. In this example, the names of biomarkers detected are not displayed. Instead, the user is given only the cost of viewing more detailed results of each biomarker. Additionally, the user is shown that a base fee 654 of $1,200 will be assessed for the analysis, regardless of selected biomarkers. For example, this base fee may be allocated, at least in part, to generation of the biological data, such as, e.g., by whole genome sequencing. In addition, or as an alternative, the base fee may be allocated to performing the analysis on the biological data. As in FIG. 6A above, the user may submit payment information via button 662, or cancel via button 660. Cancellation may still require payment of a base fee 654 in some embodiments. In other embodiments, a payment account or credit will have already been established, and the user may be required to “log in” in a manner well understood before being able to request services or analysis.

With reference now to FIG. 2B, an illustrative interaction for receiving detailed biomarker results will be described. The client computing device 114 may submit biomarker selection information and payment information to the biological data processing server 106. Such submission may utilize web-based user interfaces 600 or 650 shown in FIGS. 6A and B, as described above. The biological data processing server 106 may then format detailed results for the selected biomarkers. Such detailed results may include specific information on the biomarkers detected in biological data, such as increased proclivity for disease, increased effectiveness of drug treatment, or other information associated with the detected biomarker. The biological data processing server then submits the received payment information to the license and payment server 104. The license and payment server 104 then processes the submitted payment information and confirms payment to the biological data processing server. As will be appreciated by one skilled in the art, processing of payment information may require communication with one or more elements not shown, such as financial institutions or other payment processing systems. Further, processing the payment information may include processing payment to one or more licensors associated with selected biomarkers. In various embodiments, such payment to licensors may be accomplished by transmitting payment directly to licensors, by keeping account of fees owed to licensors, or by any other systems consistent with the licensing information or licensing agreements of the selected biomarkers.

Though formatting of detailed results for the selected biomarkers is discussed previous to submission, processing, and confirmation of payment information, one skilled in the art will appreciate that the processes may be accomplished simultaneously or in any order while still falling within the scope of the present disclosure.

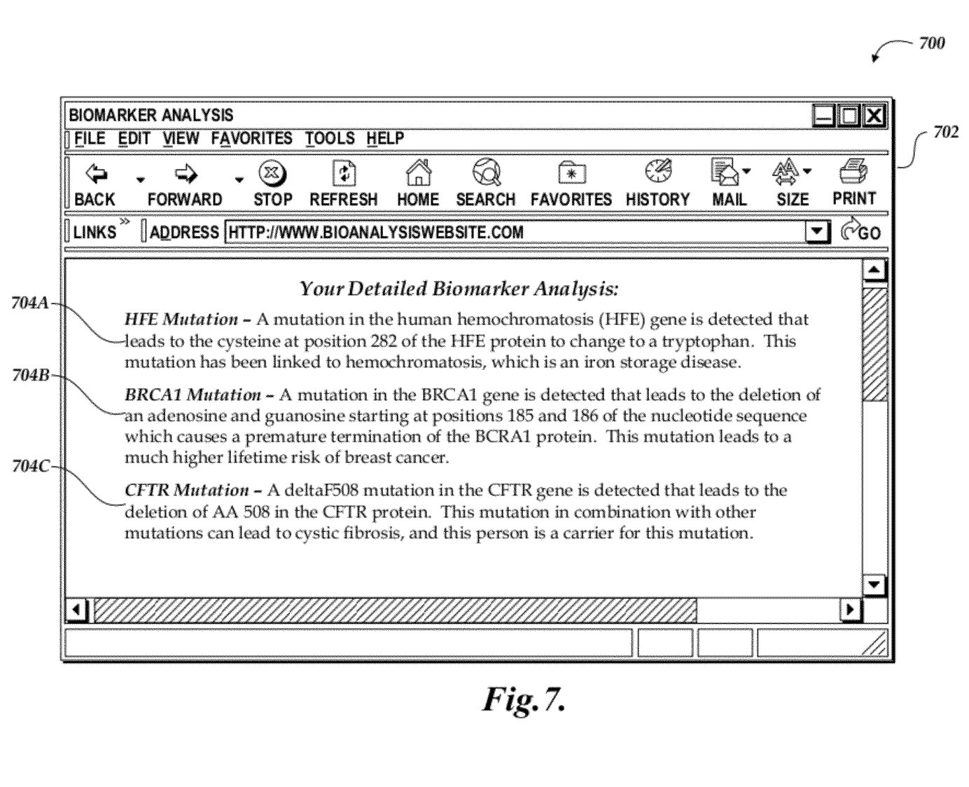

Once detailed results are formatted and payment is confirmed, the biological data processing server 106 may transmit the detailed results and confirmation of payment to the computing device 114 or another computing device of the user's designation. One example of a web-based interface for receiving such detailed results is user interface 700 shown in FIG. 7. As seen in FIG. 7, interface window 702 includes information regarding three detected biomarkers 704A-C. These detailed results correspond to biomarkers previously selected, such as by user interface 600 shown in FIG. 6A, or by user interface 650 shown in FIG. 6B. Not shown is that after payment is confirmed the user may choose to share some or all parts of information generated via a social media service (e.g., Genection, Facebook, Twitter, etc.).

In some embodiments, any of the interactions described above with respect to FIG. 2A and FIG. 2B may be performed in real time or substantially real time. For example, where a computing device 114 is a wearable or wholly or partially implantable computing device configured to monitor one or more physiological parameters and transmit biological data to the biological data processing server. One or more of the interactions described above may be omitted, for example a user may have preauthorized acceptance of license terms and/or license fee payment such that no further user authorization is required.

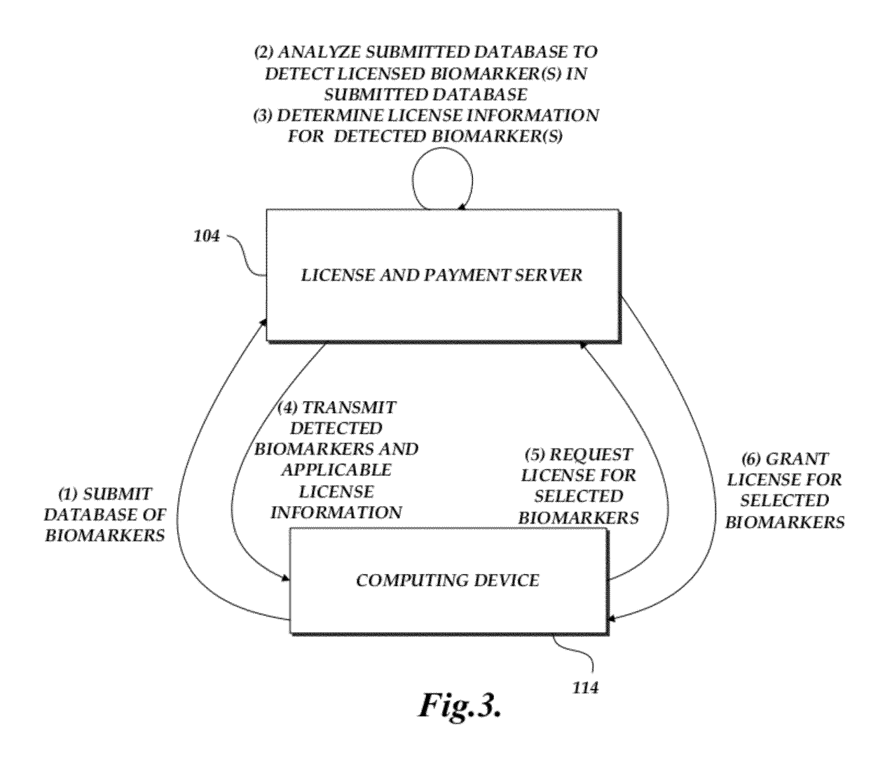

With reference now to FIG. 3, an illustrative analysis of a biomarker data set for determination of licensed biomarkers and associated fees will be described. As shown in FIG. 3, a computing device 114 may submit a database or data set of biomarkers to the licensing and payment server 104. Such submission may be made, for example, where it is unknown whether the submitted database contains biomarkers subject to restricted rights, or where license fees for biomarkers within the dataset are unknown. In other embodiments, the restricted use status of biomarkers within the submitted database may be known, but a user may wish to take advantage of license arrangements available through the license management provider 102.

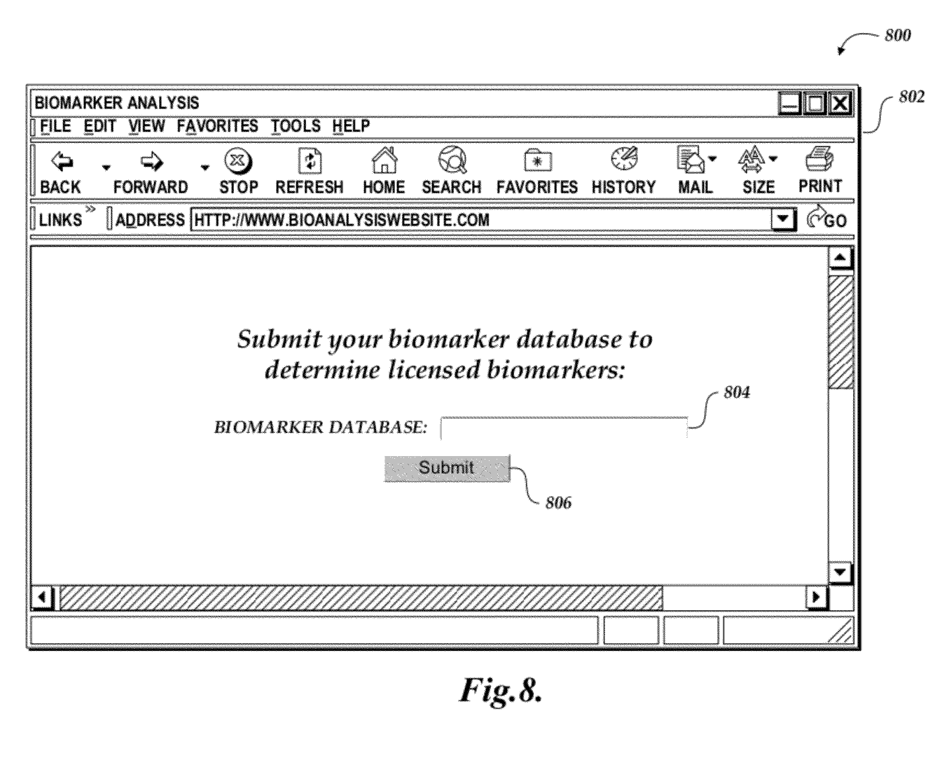

One example of a user interface for such a biomarker database is web-based user interface 800 shown in FIG. 8. As shown in FIG. 8, interface window 802 allows a user to input the location (e.g., a file name, address, etc.) of a biomarker database in input box 804. By way of non-limiting example, a biomarker database may correspond to biomarker information from a single source or from multiple sources; for example, a biomarker database may comprise sequences of gene mutations, sequences of polymorphisms, nucleic acid sequences, RNA expression data, protein expression data, data on lipid compositions, and data on restriction site mapping. One skilled in the art will appreciate that a biomarker database may correspond to any collection of biomarker information. After a location of a biomarker database is input, the computing device 114 may submit the biomarker database to the license and payment server 104 by user selection of the submit button 806.

With continued reference to FIG. 3, after a database of biomarkers has been submitted, the license and payment server 104 may determine which biomarkers, if any, in the submitted biological data are subject to restricted use. Such determination may be based, for example, on a maintained data set of licensed biomarkers, on a listing of available biomarker licensing agreements, or on other information gathered by the license and payment server 104 pertaining to licensed biomarkers. Once licensed biomarkers within the submitted database are detected, the license and payment server 104 may determine the license information associated with the detected biomarkers. The license information may correspond to licensing fees, identities of licensors, license terms, or other information associated with the detected biomarkers. One example of a routine to determine licensing information is discussed below with reference to FIG. 4. After determination of licensing information, the licensing information and information pertaining to the detected biomarkers is transmitted to the computing device 114.

In some embodiments, the user of the computing device 114 may wish to enter into a license agreement relating to one or more of the detected biomarkers. The computing device 114 may then request a license for the selected biomarkers from the license and payment server 104. The license and payment server may then grant a license to the user of the client computing device 114 associated with the detected biomarkers. Such a license agreement may define fees associated with use of the detected biomarkers or may further define amounts to be paid to rights holders of the licensed biomarkers covered under the license agreement. In still more embodiments, the license agreement may specify additional licensing terms. Such terms may include provisions that new biomarkers detected during use associated with the licensed biomarkers are the intellectual property of the operator of the license and payment server, the rights holder of a licensed biomarker or biomarkers, or another entity.

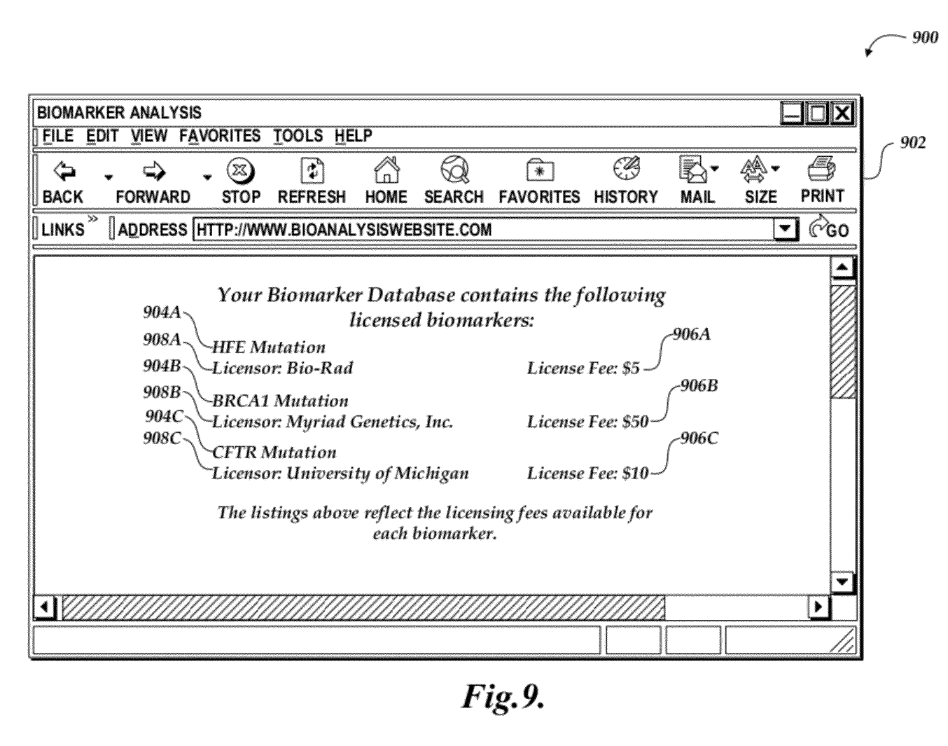

One example of a user interface for displaying such transmitted information is the web-based user interface 900 shown in FIG. 9. As shown in FIG. 9, interface window 902 allows a computing device, such as computing device 114 shown in FIG. 3, to receive license information pertaining to a submitted data set of biomarkers. Biomarker information 904A-C corresponds to names of biomarkers detected within a submitted biomarker dataset or database. Biomarker information 908A-C corresponds to the licensor associated with the detected biomarkers, and biomarker information 906A-C corresponds to licensing fees associated with each detected biomarker. As described above, the biomarker information displayed by the user interface 900 may include any further license information pertaining to the detected biomarkers.

With reference now to FIG. 4, one embodiment of a routine 400 implemented by the license and payment processing server 104 for determining license information of a set of biomarkers will be described. At block 402, the license and payment processing server 104 receives a list of detected biomarkers. This list could correspond to any information identifying biomarkers on which license information is desired. At block 404, the licensor for each detected biomarker is determined. Such determination may be based, for example, on a maintained data set of licensor information, on a listing of available biomarker licensing agreements, or on other information gathered by the license and payment server 104 pertaining to licensed biomarkers. At block 406, license information corresponding to each identified licensor is retrieved. This retrieved license information is then used in conjunction with the identified licensors at block 408 to calculate a licensing fee for each identified licensor and detected biomarker. The calculation of licensing fees may vary depending on the underlying licensing agreements associated with each biomarker. As will be appreciated by one skilled in the art, such license agreements may assign a variety of license fees to a biomarker. Once license fees for the detected biomarkers have been determined, at block 410 the license fee and licensor information may be returned. This routine may correspond, for example, to determination of license information by the license and payment server 104 as shown in FIG. 2A, or to determination of license information by the license and payment server 104, as shown in FIG. 3. The user may authorize payment at that point, or if payment is preauthorized, the appropriate account can be automatically charged or debited.

Although the process described above involves the user of a computing device 114 in order to interface with either a biological data processing server 106 or a license and payment server 104, one skilled in the art will appreciate that the process may be carried out via various modes of interaction. In some embodiments, for instance, a laboratory 110 of FIG. 1 may submit biological data to the biological data processing server 106. Other methods of submission and interaction by a user will be apparent to one skilled in the art without departing from the scope of the current disclosure. In addition, in various embodiments of the disclosure, a biomarker may be determined which is not subject to restricted use, or for which no licensing information is available. As will be appreciated by one skilled in the art, license or licensing information as described herein may further reflect that a biomarker is not subject to restrictions, or that the licensing status of a biomarker could not be determined.

It will be appreciated by those skilled in the art and others that all of the functions described in this disclosure may be embodied in software executed by one or more processors of the disclosed components and mobile communication devices. The software may be persistently stored in any type of non-volatile storage.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. Further, any process descriptions, elements, or blocks described herein may be implemented or executed by individual systems or devices, or by multiple systems or devices acting collectively or conjointly. It will further be appreciated that the data and/or components described above may be stored on a computer-readable medium and loaded into memory of the computing device using a drive mechanism associated with a computer readable storing the computer executable components such as a CD-ROM, DVD-ROM, or network interface further, the component and/or data can be included in a single device or distributed in any manner. Accordingly, general purpose computing devices may be configured to implement the processes, algorithms and methodology of the present disclosure with the processing and/or execution of the various data and/or components described above.

While the foregoing written description enables one of ordinary skill to make and use what is considered presently to be the best mode thereof, those skilled in the art will understand and appreciate the existence of variations, combinations, and equivalents of the specific embodiment, method, and examples herein. The present embodiments should therefore not be limited by the above described embodiment, method, and examples, but by all embodiments and methods within the scope and spirit of the present embodiments.

The following Example is presented for the purpose of illustration and should not be construed as limiting.

### Example 1

Analysis of Somatic or Acquired Biomarkers: Screening for AML Panel Mutations Using Next Generation Sequencing

Next generation sequencing is a tool that can be used to determine the mutation status of DNA isolated from subjects, such as subjects diagnosed with acute myeloid leukemia (AML). The methodology enables the analysis of multiple individuals in parallel and can be completed in the space of a relatively short time. One of the most commonly used AML Biomarker Panel utilizes characterized mutations in the FLT3-ITD, FL3-TKD, and NPM1 genes as biomarkers.

Mutations of the fms-related tyrosine kinase 3 (FLT3) are among the most common mutations in acute myeloid leukemia, occurring in approximately ¼ of patients. There are two major types of FLT3 mutations: internal tandem duplication (ITD) or length mutations (LM) that map primarily within the juxtamembrane region of FLT3 (15-20% of AML patients), and point mutations in the kinase domain that most frequently involve aspartic acid 835 (D835 mutations) but have also been found less frequently in several other sites (5-10% of AML patients).

NPM1 nucleophosmin mutations are among the most prevalent mutations in karyotype normal AML (25-35% of AML patients). In the absence of FLT3-ITD mutations, NPM1 mutations portend a more favorable outcome for patients with AML. There is some evidence to suggest that NPM1 mutations provide a protective or favorable benefit even in patients with FLT3-ITD mutations.

FLT3-ITD Analysis: How to work a sample for FLT3 mutation status through the 454 Genome Sequencer: an example of next generation sequencing potential.

Primer Design: The primers used for sample amplification include 3 distinct regions: a 19 base pair fusion primer for sequencing, a 10 base pair Multiplex Identifier (MID) adaptor to differentiate individual samples, and the FLT3 primer sequence. The fusion primer segment is specific to the sequencing chemistry and has two iterations, A and B, which identify forward and reverse sequence reads during data analysis. The MID adaptor functions as a barcode, enabling multiplexing of sample processing as well as sample classification of the final data output in the GS Amplicon Variant Analyzer Software. Examples of MID adaptors are disclosed at SEQ ID NOs: 201-250.

More specifically, the forward and reverse FLT3 ITD primers are designed as follows:

TABLE 1
ITD Forward Fusion Primers

| | MID | | | |
|---|---|---|---|---|
| SEQ ID | Tag | Fusion Primer | MID | FLT3 ITD Forward |
| NO | Name | A (19 bp) | (10 bp) | Gene Specific |
| SEQ ID | MID-1 | GCCTCCCTCGCGCCATCAG | ACGAGTGCGT | GCAATTTAGGTATGAAAGCCAGC |
| NO: 1 | | | | |
| SEQ ID | MID-2 | GCCTCCCTCGCGCCATCAG | ACGCTCGACA | GCAATTTAGGTATGAAAGCCAGC |
| NO: 2 | | | | |
| SEQ ID | MID-3 | GCCTCCCTCGCGCCATCAG | AGACGCACTC | GCAATTTAGGTATGAAAGCCAGC |
| NO: 3 | | | | |
| SEQ ID | MID-4 | GCCTCCCTCGCGCCATCAG | AGCACTGTAG | GCAATTTAGGTATGAAAGCCAGC |
| NO: 4 | | | | |
| SEQ ID | MID-5 | GCCTCCCTCGCGCCATCAG | ATCAGACACG | GCAATTTAGGTATGAAAGCCAGC |
| NO: 5 | | | | |
| SEQ ID | MID-6 | GCCTCCCTCGCGCCATCAG | ATATCGCGAG | GCAATTTAGGTATGAAAGCCAGC |
| NO: 6 | | | | |
| SEQ ID | MID-7 | GCCTCCCTCGCGCCATCAG | CGTGTCTCTA | GCAATTTAGGTATGAAAGCCAGC |
| NO: 7 | | | | |
| SEQ ID | MID-8 | GCCTCCCTCGCGCCATCAG | CTCGCGTGTC | GCAATTTAGGTATGAAAGCCAGC |
| NO: 8 | | | | |
| SEQ ID | MID-10 | GCCTCCCTCGCGCCATCAG | TCTCTATGCG | GCAATTTAGGTATGAAAGCCAGC |
| NO: 9 | | | | |
| SEQ ID | MID-11 | GCCTCCCTCGCGCCATCAG | TGATACGTCT | GCAATTTAGGTATGAAAGCCAGC |
| NO: 10 | | | | |
| SEQ ID | MID-13 | GCCTCCCTCGCGCCATCAG | CATAGTAGTG | GCAATTTAGGTATGAAAGCCAGC |
| NO: 11 | | | | |
| SEQ ID | MID-14 | GCCTCCCTCGCGCCATCAG | CGAGAGATAC | GCAATTTAGGTATGAAAGCCAGC |
| NO: 12 | | | | |
| SEQ ID | MID-15 | GCCTCCCTCGCGCCATCAG | ATACGACGTA | GCAATTTAGGTATGAAAGCCAGC |
| NO: 13 | | | | |
| SEQ ID | MID-16 | GCCTCCCTCGCGCCATCAG | TCACGTACTA | GCAATTTAGGTATGAAAGCCAGC |
| NO: 14 | | | | |
| SEQ ID | MID-17 | GCCTCCCTCGCGCCATCAG | CGTCTAGTAC | GCAATTTAGGTATGAAAGCCAGC |
| NO: 15 | | | | |
| SEQ ID | MID-18 | GCCTCCCTCGCGCCATCAG | TCTACGTAGC | GCAATTTAGGTATGAAAGCCAGC |
| NO: 16 | | | | |
| SEQ ID | MID-19 | GCCTCCCTCGCGCCATCAG | TGTACTACTC | GCAATTTAGGTATGAAAGCCAGC |
| NO: 17 | | | | |
| SEQ ID | MID-20 | GCCTCCCTCGCGCCATCAG | ACGACTACAG | GCAATTTAGGTATGAAAGCCAGC |
| NO: 18 | | | | |
| SEQ ID | MID-21 | GCCTCCCTCGCGCCATCAG | CGTAGACTAG | GCAATTTAGGTATGAAAGCCAGC |
| NO: 19 | | | | |
| SEQ ID | MID-22 | GCCTCCCTCGCGCCATCAG | TACGAGTATG | GCAATTTAGGTATGAAAGCCAGC |
| NO: 20 | | | | |
| SEQ ID | MID-23 | GCCTCCCTCGCGCCATCAG | TACTCTCGTG | GCAATTTAGGTATGAAAGCCAGC |
| NO: 21 | | | | |
| SEQ ID | MID-24 | GCCTCCCTCGCGCCATCAG | TAGAGACGA | GCAATTTAGGTATGAAAGCCAGC |
| NO: 22 | | | G | |
| SEQ ID | MID-25 | GCCTCCCTCGCGCCATCAG | TCGTCGCTCG | GCAATTTAGGTATGAAAGCCAGC |
| NO: 23 | | | | |
| SEQ ID | MID-26 | GCCTCCCTCGCGCCATCAG | ACATACGCGT | GCAATTTAGGTATGAAAGCCAGC |
| NO: 24 | | | | |
| SEQ ID | MID-27 | GCCTCCCTCGCGCCATCAG | ACGCGAGTAT | GCAATTTAGGTATGAAAGCCAGC |
| NO: 25 | | | | |
| SEQ ID | MID-28 | GCCTCCCTCGCGCCATCAG | ACTACTATGT | GCAATTTAGGTATGAAAGCCAGC |
| NO: 26 | | | | |
| SEQ ID | MID-29 | GCCTCCCTCGCGCCATCAG | ACTGTACAGT | GCAATTTAGGTATGAAAGCCAGC |
| NO: 27 | | | | |
| SEQ ID | MID-30 | GCCTCCCTCGCGCCATCAG | AGACTATACT | GCAATTTAGGTATGAAAGCCAGC |
| NO: 28 | | | | |
| SEQ ID | MID-31 | GCCTCCCTCGCGCCATCAG | AGCGTCGTCT | GCAATTTAGGTATGAAAGCCAGC |
| NO: 29 | | | | |
| SEQ ID | MID-32 | GCCTCCCTCGCGCCATCAG | AGTACGCTAT | GCAATTTAGGTATGAAAGCCAGC |
| NO: 30 | | | | |
| SEQ ID | MID-33 | GCCTCCCTCGCGCCATCAG | ATAGAGTACT | GCAATTTAGGTATGAAAGCCAGC |
| NO: 31 | | | | |
| SEQ ID | MID-34 | GCCTCCCTCGCGCCATCAG | CACGCTACGT | GCAATTTAGGTATGAAAGCCAGC |
| NO: 32 | | | | |
| SEQ ID | MID-35 | GCCTCCCTCGCGCCATCAG | CAGTAGACGT | GCAATTTAGGTATGAAAGCCAGC |
| NO: 33 | | | | |
| SEQ ID | MID-36 | GCCTCCCTCGCGCCATCAG | CGACGTGACT | GCAATTTAGGTATGAAAGCCAGC |
| NO: 34 | | | | |
| SEQ ID | MID-37 | GCCTCCCTCGCGCCATCAG | TACACACACT | GCAATTTAGGTATGAAAGCCAGC |
| NO: 35 | | | | |
| SEQ ID | MID-38 | GCCTCCCTCGCGCCATCAG | TACACGTGAT | GCAATTTAGGTATGAAAGCCAGC |
| NO: 36 | | | | |
| SEQ ID | MID-39 | GCCTCCCTCGCGCCATCAG | TACAGATCGT | GCAATTTAGGTATGAAAGCCAGC |
| NO: 37 | | | | |
| SEQ ID | MID-40 | GCCTCCCTCGCGCCATCAG | TACGCTGTCT | GCAATTTAGGTATGAAAGCCAGC |
| NO: 38 | | | | |
| SEQ ID | MID-41 | GCCTCCCTCGCGCCATCAG | TAGTGTAGAT | GCAATTTAGGTATGAAAGCCAGC |
| NO: 39 | | | | |
| SEQ ID | MID-42 | GCCTCCCTCGCGCCATCAG | TCGATCACGT | GCAATTTAGGTATGAAAGCCAGC |
| NO: 40 | | | | |
| SEQ ID | MID-43 | GCCTCCCTCGCGCCATCAG | TCGCACTAGT | GCAATTTAGGTATGAAAGCCAGC |
| NO: 41 | | | | |
| SEQ ID | MID-44 | GCCTCCCTCGCGCCATCAG | TCTAGCGACT | GCAATTTAGGTATGAAAGCCAGC |
| NO: 42 | | | | |
| SEQ ID | MID-45 | GCCTCCCTCGCGCCATCAG | TCTATACTAT | GCAATTTAGGTATGAAAGCCAGC |
| NO: 43 | | | | |
| SEQ ID | MID-46 | GCCTCCCTCGCGCCATCAG | TGACGTATGT | GCAATTTAGGTATGAAAGCCAGC |
| NO: 44 | | | | |
| SEQ ID | MID-47 | GCCTCCCTCGCGCCATCAG | TGTGAGTAGT | GCAATTTAGGTATGAAAGCCAGC |
| NO: 45 | | | | |
| SEQ ID | MID-48 | GCCTCCCTCGCGCCATCAG | ACAGTATATA | GCAATTTAGGTATGAAAGCCAGC |
| NO: 46 | | | | |
| SEQ ID | MID-49 | GCCTCCCTCGCGCCATCAG | ACGCGATCGA | GCAATTTAGGTATGAAAGCCAGC |
| NO: 47 | | | | |
| SEQ ID | MID-50 | GCCTCCCTCGCGCCATCAG | ACTAGCAGTA | GCAATTTAGGTATGAAAGCCAGC |
| NO: 48 | | | | |
| SEQ ID | MID-51 | GCCTCCCTCGCGCCATCAG | AGCTCACGTA | GCAATTTAGGTATGAAAGCCAGC |
| NO: 49 | | | | |
| SEQ ID | MID-52 | GCCTCCCTCGCGCCATCAG | AGTATACATA | GCAATTTAGGTATGAAAGCCAGC |
| NO: 50 | | | | |

TABLE 2
ITD Reverse Fusion Primers

| | MID | | | |
|---|---|---|---|---|
| SEQ ID | Tag | Fusion Primer | MID | FLT3 ITD Reverse |
| NO: | Name | B (19 bp) | (10 bp) | Gene Specific |
| SEQ ID | MID-1 | GCCTTGCCAGCCCGCTCAG | ACGAGTGCGT | CTTTCAGCATTTTGACGGCAACC |
| NO: 51 | | | | |
| SEQ ID | MID-2 | GCCTTGCCAGCCCGCTCAG | ACGCTCGACA | CTTTCAGCATTTTGACGGCAACC |
| NO: 52 | | | | |
| SEQ ID | MID-3 | GCCTTGCCAGCCCGCTCAG | AGACGCACTC | CTTTCAGCATTTTGACGGCAACC |
| NO: 53 | | | | |
| SEQ ID | MID-4 | GCCTTGCCAGCCCGCTCAG | AGCACTGTAG | CTTTCAGCATTTTGACGGCAACC |
| NO: 54 | | | | |
| SEQ ID | MID-5 | GCCTTGCCAGCCCGCTCAG | ATCAGACACG | CTTTCAGCATTTTGACGGCAACC |
| NO: 55 | | | | |
| SEQ ID | MID-6 | GCCTTGCCAGCCCGCTCAG | ATATCGCGAG | CTTTCAGCATTTTGACGGCAACC |
| NO: 56 | | | | |
| SEQ ID | MID-7 | GCCTTGCCAGCCCGCTCAG | CGTGTCTCTA | CTTTCAGCATTTTGACGGCAACC |
| NO: 57 | | | | |
| SEQ ID | MID-8 | GCCTTGCCAGCCCGCTCAG | CTCGCGTGTC | CTTTCAGCATTTTGACGGCAACC |
| NO: 58 | | | | |
| SEQ ID | MID-10 | GCCTTGCCAGCCCGCTCAG | TCTCTATGCG | CTTTCAGCATTTTGACGGCAACC |
| NO: 59 | | | | |
| SEQ ID | MID-11 | GCCTTGCCAGCCCGCTCAG | TGATACGTCT | CTTTCAGCATTTTGACGGCAACC |
| NO: 60 | | | | |
| SEQ ID | MID-13 | GCCTTGCCAGCCCGCTCAG | CATAGTAGTG | CTTTCAGCATTTTGACGGCAACC |
| NO: 61 | | | | |
| SEQ ID | MID-14 | GCCTTGCCAGCCCGCTCAG | CGAGAGATAC | CTTTCAGCATTTTGACGGCAACC |
| NO: 62 | | | | |
| SEQ ID | MID-15 | GCCTTGCCAGCCCGCTCAG | ATACGACGTA | CTTTCAGCATTTTGACGGCAACC |
| NO: 63 | | | | |
| SEQ ID | MID-16 | GCCTTGCCAGCCCGCTCAG | TCACGTACTA | CTTTCAGCATTTTGACGGCAACC |
| NO: 64 | | | | |
| SEQ ID | MID-17 | GCCTTGCCAGCCCGCTCAG | CGTCTAGTAC | CTTTCAGCATTTTGACGGCAACC |
| NO: 65 | | | | |
| SEQ ID | MID-18 | GCCTTGCCAGCCCGCTCAG | TCTACGTAGC | CTTTCAGCATTTTGACGGCAACC |
| NO: 66 | | | | |
| SEQ ID | MID-19 | GCCTTGCCAGCCCGCTCAG | TGTACTACTC | CTTTCAGCATTTTGACGGCAACC |
| NO: 67 | | | | |
| SEQ ID | MID-20 | GCCTTGCCAGCCCGCTCAG | ACGACTACAG | CTTTCAGCATTTTGACGGCAACC |
| NO: 68 | | | | |
| SEQ ID | MID-21 | GCCTTGCCAGCCCGCTCAG | CGTAGACTAG | CTTTCAGCATTTTGACGGCAACC |
| NO: 69 | | | | |
| SEQ ID | MID-22 | GCCTTGCCAGCCCGCTCAG | TACGAGTATG | CTTTCAGCATTTTGACGGCAACC |
| NO: 70 | | | | |
| SEQ ID | MID-23 | GCCTTGCCAGCCCGCTCAG | TACTCTCGTG | CTTTCAGCATTTTGACGGCAACC |
| NO: 71 | | | | |
| SEQ ID | MID-24 | GCCTTGCCAGCCCGCTCAG | TAGAGACGAG | CTTTCAGCATTTTGACGGCAACC |
| NO: 72 | | | | |
| SEQ ID | MID-25 | GCCTTGCCAGCCCGCTCAG | TCGTCGCTCG | CTTTCAGCATTTTGACGGCAACC |
| NO: 73 | | | | |
| SEQ ID | MID-26 | GCCTTGCCAGCCCGCTCAG | ACATACGCGT | CTTTCAGCATTTTGACGGCAACC |
| NO: 74 | | | | |
| SEQ ID | MID-27 | GCCTTGCCAGCCCGCTCAG | ACGCGAGTAT | CTTTCAGCATTTTGACGGCAACC |
| NO: 75 | | | | |
| SEQ ID | MID-28 | GCCTTGCCAGCCCGCTCAG | ACTACTATGT | CTTTCAGCATTTTGACGGCAACC |
| NO: 76 | | | | |
| SEQ ID | MID-29 | GCCTTGCCAGCCCGCTCAG | ACTGTACAGT | CTTTCAGCATTTTGACGGCAACC |
| NO: 77 | | | | |
| SEQ ID | MID-30 | GCCTTGCCAGCCCGCTCAG | AGACTATACT | CTTTCAGCATTTTGACGGCAACC |
| NO: 78 | | | | |
| SEQ ID | MID-31 | GCCTTGCCAGCCCGCTCAG | AGCGTCGTCT | CTTTCAGCATTTTGACGGCAACC |
| NO: 79 | | | | |
| SEQ ID | MID-32 | GCCTTGCCAGCCCGCTCAG | AGTACGCTAT | CTTTCAGCATTTTGACGGCAACC |
| NO: 80 | | | | |
| SEQ ID | MID-33 | GCCTTGCCAGCCCGCTCAG | ATAGAGTACT | CTTTCAGCATTTTGACGGCAACC |
| NO: 81 | | | | |
| SEQ ID | MID-34 | GCCTTGCCAGCCCGCTCAG | CACGCTACGT | CTTTCAGCATTTTGACGGCAACC |
| NO: 82 | | | | |
| SEQ ID | MID-35 | GCCTTGCCAGCCCGCTCAG | CAGTAGACGT | CTTTCAGCATTTTGACGGCAACC |
| NO: 83 | | | | |
| SEQ ID | MID-36 | GCCTTGCCAGCCCGCTCAG | CGACGTGACT | CTTTCAGCATTTTGACGGCAACC |
| NO: 84 | | | | |
| SEQ ID | MID-37 | GCCTTGCCAGCCCGCTCAG | TACACACACT | CTTTCAGCATTTTGACGGCAACC |
| NO: 85 | | | | |
| SEQ ID | MID-38 | GCCTTGCCAGCCCGCTCAG | TACACGTGAT | CTTTCAGCATTTTGACGGCAACC |
| NO: 86 | | | | |
| SEQ ID | MID-39 | GCCTTGCCAGCCCGCTCAG | TACAGATCGT | CTTTCAGCATTTTGACGGCAACC |
| NO: 87 | | | | |
| SEQ ID | MID-40 | GCCTTGCCAGCCCGCTCAG | TACGCTGTCT | CTTTCAGCATTTTGACGGCAACC |
| NO: 88 | | | | |
| SEQ ID | MID-41 | GCCTTGCCAGCCCGCTCAG | TAGTGTAGAT | CTTTCAGCATTTTGACGGCAACC |
| NO: 89 | | | | |
| SEQ ID | MID-42 | GCCTTGCCAGCCCGCTCAG | TCGATCACGT | CTTTCAGCATTTTGACGGCAACC |
| NO: 90 | | | | |
| SEQ ID | MID-43 | GCCTTGCCAGCCCGCTCAG | TCGCACTAGT | CTTTCAGCATTTTGACGGCAACC |
| NO: 91 | | | | |
| SEQ ID | MID-44 | GCCTTGCCAGCCCGCTCAG | TCTAGCGACT | CTTTCAGCATTTTGACGGCAACC |
| NO: 92 | | | | |
| SEQ ID | MID-45 | GCCTTGCCAGCCCGCTCAG | TCTATACTAT | CTTTCAGCATTTTGACGGCAACC |
| NO: 93 | | | | |
| SEQ ID | MID-46 | GCCTTGCCAGCCCGCTCAG | TGACGTATGT | CTTTCAGCATTTTGACGGCAACC |
| NO: 94 | | | | |
| SEQ ID | MID-47 | GCCTTGCCAGCCCGCTCAG | TGTGAGTAGT | CTTTCAGCATTTTGACGGCAACC |
| NO: 95 | | | | |
| SEQ ID | MID-48 | GCCTTGCCAGCCCGCTCAG | ACAGTATATA | CTTTCAGCATTTTGACGGCAACC |
| NO: 96 | | | | |
| SEQ ID | MID-49 | GCCTTGCCAGCCCGCTCAG | ACGCGATCGA | CTTTCAGCATTTTGACGGCAACC |
| NO: 97 | | | | |
| SEQ ID | MID-50 | GCCTTGCCAGCCCGCTCAG | ACTAGCAGTA | CTTTCAGCATTTTGACGGCAACC |
| NO: 98 | | | | |
| SEQ ID | MID-51 | GCCTTGCCAGCCCGCTCAG | AGCTCACGTA | CTTTCAGCATTTTGACGGCAACC |
| NO: 99 | | | | |
| SEQ ID | MID-52 | GCCTTGCCAGCCCGCTCAG | AGTATACATA | CTTTCAGCATTTTGACGGCAACC |
| NO: 100 | | | | |

Tables 1 and 2 show the sequences of forward and reverse primers, respectively, which may be used to sequence ITD mutations in the FLT3 gene. Tables 3 and 4 show the sequences of forward and reverse primers, respectively, which may be used to sequence D835 mutations in the FLT3 gene.

TABLE 3
D835 Forward Primers

| | MID | | | |
|---|---|---|---|---|
| SEQ ID | Tag | | | FLT3 D835 Forward |
| NO | Name | Fusion Primer A (19 bp) | MID (10 bp) | Gene Specific |
| SEQ ID | MID-1 | GCCTCCCTCGCGCCATCAG | ACGAGTGCGT | GCCGCCAGGAACGTGCTTG |
| NO: 101 | | | | |
| SEQ ID | MID-2 | GCCTCCCTCGCGCCATCAG | ACGCTCGACA | GCCGCCAGGAACGTGCTTG |
| NO: 102 | | | | |
| SEQ ID | MID-3 | GCCTCCCTCGCGCCATCAG | AGACGCACTC | GCCGCCAGGAACGTGCTTG |
| NO: 103 | | | | |
| SEQ ID | MID-4 | GCCTCCCTCGCGCCATCAG | AGCACTGTAG | GCCGCCAGGAACGTGCTTG |
| NO: 104 | | | | |
| SEQ ID | MID-5 | GCCTCCCTCGCGCCATCAG | ATCAGACACG | GCCGCCAGGAACGTGCTTG |
| NO: 105 | | | | |
| SEQ ID | MID-6 | GCCTCCCTCGCGCCATCAG | ATATCGCGAG | GCCGCCAGGAACGTGCTTG |
| NO: 106 | | | | |
| SEQ ID | MID-7 | GCCTCCCTCGCGCCATCAG | CGTGTCTCTA | GCCGCCAGGAACGTGCTTG |
| NO: 107 | | | | |
| SEQ ID | MID-8 | GCCTCCCTCGCGCCATCAG | CTCGCGTGTC | GCCGCCAGGAACGTGCTTG |
| NO: 108 | | | | |
| SEQ ID | MID- | GCCTCCCTCGCGCCATCAG | TCTCTATGCG | GCCGCCAGGAACGTGCTTG |
| NO: 109 | 10 | | | |
| SEQ ID | MID- | GCCTCCCTCGCGCCATCAG | TGATACGTCT | GCCGCCAGGAACGTGCTTG |
| NO: 110 | 11 | | | |
| SEQ ID | MID- | GCCTCCCTCGCGCCATCAG | CATAGTAGTG | GCCGCCAGGAACGTGCTTG |
| NO: 111 | 13 | | | |
| SEQ ID | MID- | GCCTCCCTCGCGCCATCAG | CGAGAGATAC | GCCGCCAGGAACGTGCTTG |
| NO: 112 | 14 | | | |
| SEQ ID | MID- | GCCTCCCTCGCGCCATCAG | ATACGACGTA | GCCGCCAGGAACGTGCTTG |
| NO: 113 | 15 | | | |
| SEQ ID | MID- | GCCTCCCTCGCGCCATCAG | TCACGTACTA | GCCGCCAGGAACGTGCTTG |
| NO: 114 | 16 | | | |
| SEQ ID | MID- | GCCTCCCTCGCGCCATCAG | CGTCTAGTAC | GCCGCCAGGAACGTGCTTG |
| NO: 115 | 17 | | | |
| SEQ ID | MID- | GCCTCCCTCGCGCCATCAG | TCTACGTAGC | GCCGCCAGGAACGTGCTTG |
| NO: 116 | 18 | | | |
| SEQ ID | MID- | GCCTCCCTCGCGCCATCAG | TGTACTACTC | GCCGCCAGGAACGTGCTTG |
| NO: 117 | 19 | | | |
| SEQ ID | MID- | GCCTCCCTCGCGCCATCAG | ACGACTACAG | GCCGCCAGGAACGTGCTTG |
| NO: 118 | 20 | | | |
| SEQ ID | MID- | GCCTCCCTCGCGCCATCAG | CGTAGACTAG | GCCGCCAGGAACGTGCTTG |
| NO: 119 | 21 | | | |
| SEQ ID | MID- | GCCTCCCTCGCGCCATCAG | TACGAGTATG | GCCGCCAGGAACGTGCTTG |
| NO: 120 | 22 | | | |
| SEQ ID | MID- | GCCTCCCTCGCGCCATCAG | TACTCTCGTG | GCCGCCAGGAACGTGCTTG |
| NO: 121 | 23 | | | |
| SEQ ID | MID- | GCCTCCCTCGCGCCATCAG | TAGAGACGAG | GCCGCCAGGAACGTGCTTG |
| NO: 122 | 24 | | | |
| SEQ ID | MID- | GCCTCCCTCGCGCCATCAG | TCGTCGCTCG | GCCGCCAGGAACGTGCTTG |
| NO: 123 | 25 | | | |
| SEQ ID | MID- | GCCTCCCTCGCGCCATCAG | ACATACGCGT | GCCGCCAGGAACGTGCTTG |
| NO: 124 | 26 | | | |
| SEQ ID | MID- | GCCTCCCTCGCGCCATCAG | ACGCGAGTAT | GCCGCCAGGAACGTGCTTG |
| NO: 125 | 27 | | | |
| SEQ ID | MID- | GCCTCCCTCGCGCCATCAG | ACTACTATGT | GCCGCCAGGAACGTGCTTG |
| NO: 126 | 28 | | | |
| SEQ ID | MID- | GCCTCCCTCGCGCCATCAG | ACTGTACAGT | GCCGCCAGGAACGTGCTTG |
| NO: 127 | 29 | | | |
| SEQ ID | MID- | GCCTCCCTCGCGCCATCAG | AGACTATACT | GCCGCCAGGAACGTGCTTG |
| NO: 128 | 30 | | | |
| SEQ ID | MID- | GCCTCCCTCGCGCCATCAG | AGCGTCGTCT | GCCGCCAGGAACGTGCTTG |
| NO: 129 | 31 | | | |
| SEQ ID | MID- | GCCTCCCTCGCGCCATCAG | AGTACGCTAT | GCCGCCAGGAACGTGCTTG |
| NO: 130 | 32 | | | |
| SEQ ID | MID- | GCCTCCCTCGCGCCATCAG | ATAGAGTACT | GCCGCCAGGAACGTGCTTG |
| NO: 131 | 33 | | | |
| SEQ ID | MID- | GCCTCCCTCGCGCCATCAG | CACGCTACGT | GCCGCCAGGAACGTGCTTG |
| NO: 132 | 34 | | | |
| SEQ ID | MID- | GCCTCCCTCGCGCCATCAG | CAGTAGACGT | GCCGCCAGGAACGTGCTTG |
| NO: 133 | 35 | | | |
| SEQ ID | MID- | GCCTCCCTCGCGCCATCAG | CGACGTGACT | GCCGCCAGGAACGTGCTTG |
| NO: 134 | 36 | | | |
| SEQ ID | MID- | GCCTCCCTCGCGCCATCAG | TACACACACT | GCCGCCAGGAACGTGCTTG |
| NO: 135 | 37 | | | |
| SEQ ID | MID- | GCCTCCCTCGCGCCATCAG | TACACGTGAT | GCCGCCAGGAACGTGCTTG |
| NO: 136 | 38 | | | |
| SEQ ID | MID- | GCCTCCCTCGCGCCATCAG | TACAGATCGT | GCCGCCAGGAACGTGCTTG |
| NO: 137 | 39 | | | |
| SEQ ID | MID- | GCCTCCCTCGCGCCATCAG | TACGCTGTCT | GCCGCCAGGAACGTGCTTG |
| NO: 138 | 40 | | | |
| SEQ ID | MID- | GCCTCCCTCGCGCCATCAG | TAGTGTAGAT | GCCGCCAGGAACGTGCTTG |
| NO: 139 | 41 | | | |
| SEQ ID | MID- | GCCTCCCTCGCGCCATCAG | TCGATCACGT | GCCGCCAGGAACGTGCTTG |
| NO: 140 | 42 | | | |
| SEQ ID | MID- | GCCTCCCTCGCGCCATCAG | TCGCACTAGT | GCCGCCAGGAACGTGCTTG |
| NO: 141 | 43 | | | |
| SEQ ID | MID- | GCCTCCCTCGCGCCATCAG | TCTAGCGACT | GCCGCCAGGAACGTGCTTG |
| NO: 142 | 44 | | | |
| SEQ ID | MID- | GCCTCCCTCGCGCCATCAG | TCTATACTAT | GCCGCCAGGAACGTGCTTG |
| NO: 143 | 45 | | | |
| SEQ ID | MID- | GCCTCCCTCGCGCCATCAG | TGACGTATGT | GCCGCCAGGAACGTGCTTG |
| NO: 144 | 46 | | | |
| SEQ ID | MID- | GCCTCCCTCGCGCCATCAG | TGTGAGTAGT | GCCGCCAGGAACGTGCTTG |
| NO: 145 | 47 | | | |
| SEQ ID | MID- | GCCTCCCTCGCGCCATCAG | ACAGTATATA | GCCGCCAGGAACGTGCTTG |
| NO: 146 | 48 | | | |
| SEQ ID | MID- | GCCTCCCTCGCGCCATCAG | ACGCGATCGA | GCCGCCAGGAACGTGCTTG |
| NO: 147 | 49 | | | |
| SEQ ID | MID- | GCCTCCCTCGCGCCATCAG | ACTAGCAGTA | GCCGCCAGGAACGTGCTTG |
| NO: 148 | 50 | | | |
| SEQ ID | MID- | GCCTCCCTCGCGCCATCAG | AGCTCACGTA | GCCGCCAGGAACGTGCTTG |
| NO: 149 | 51 | | | |
| SEQ ID | MID- | GCCTCCCTCGCGCCATCAG | AGTATACATA | GCCGCCAGGAACGTGCTTG |
| NO: 150 | 52 | | | |

TABLE 4
D835 Reverse Primers

| | MID | | | |
|---|---|---|---|---|
| SEQ ID | Tag | | MID | |
| NO | Name | PRIMER-B | SEQUENCE | FLT3 D835R SEQUENCE |
| SEQ ID | MID-1 | GCCTTGCCAGCCCGCTCAG | ACGAGTGCGT | CAGCCTCACATTGCCCC |
| NO: 151 | | | | |
| SEQ ID | MID-2 | GCCTTGCCAGCCCGCTCAG | ACGCTCGACA | CAGCCTCACATTGCCCC |
| NO: 152 | | | | |
| SEQ ID | MID-3 | GCCTTGCCAGCCCGCTCAG | AGACGCACTC | CAGCCTCACATTGCCCC |
| NO: 153 | | | | |
| SEQ ID | MID-4 | GCCTTGCCAGCCCGCTCAG | AGCACTGTAG | CAGCCTCACATTGCCCC |
| NO: 154 | | | | |
| SEQ ID | MID-5 | GCCTTGCCAGCCCGCTCAG | ATCAGACACG | CAGCCTCACATTGCCCC |
| NO: 155 | | | | |
| SEQ ID | MID-6 | GCCTTGCCAGCCCGCTCAG | ATATCGCGAG | CAGCCTCACATTGCCCC |
| NO: 156 | | | | |
| SEQ ID | MID-7 | GCCTTGCCAGCCCGCTCAG | CGTGTCTCTA | CAGCCTCACATTGCCCC |
| NO: 157 | | | | |
| SEQ ID | MID-8 | GCCTTGCCAGCCCGCTCAG | CTCGCGTGTC | CAGCCTCACATTGCCCC |
| NO: 158 | | | | |
| SEQ ID | MID-10 | GCCTTGCCAGCCCGCTCAG | TCTCTATGCG | CAGCCTCACATTGCCCC |
| NO: 159 | | | | |
| SEQ ID | MID-11 | GCCTTGCCAGCCCGCTCAG | TGATACGTCT | CAGCCTCACATTGCCCC |
| NO: 160 | | | | |
| SEQ ID | MID-13 | GCCTTGCCAGCCCGCTCAG | CATAGTAGTG | CAGCCTCACATTGCCCC |
| NO: 161 | | | | |
| SEQ ID | MID-14 | GCCTTGCCAGCCCGCTCAG | CGAGAGATAC | CAGCCTCACATTGCCCC |
| NO: 162 | | | | |
| SEQ ID | MID-15 | GCCTTGCCAGCCCGCTCAG | ATACGACGTA | CAGCCTCACATTGCCCC |
| NO: 163 | | | | |
| SEQ ID | MID-16 | GCCTTGCCAGCCCGCTCAG | TCACGTACTA | CAGCCTCACATTGCCCC |
| NO: 164 | | | | |
| SEQ ID | MID-17 | GCCTTGCCAGCCCGCTCAG | CGTCTAGTAC | CAGCCTCACATTGCCCC |
| NO: 165 | | | | |
| SEQ ID | MID-18 | GCCTTGCCAGCCCGCTCAG | TCTACGTAGC | CAGCCTCACATTGCCCC |
| NO: 166 | | | | |
| SEQ ID | MID-19 | GCCTTGCCAGCCCGCTCAG | TGTACTACTC | CAGCCTCACATTGCCCC |
| NO: 167 | | | | |
| SEQ ID | MID-20 | GCCTTGCCAGCCCGCTCAG | ACGACTACAG | CAGCCTCACATTGCCCC |
| NO: 168 | | | | |
| SEQ ID | MID-21 | GCCTTGCCAGCCCGCTCAG | CGTAGACTAG | CAGCCTCACATTGCCCC |
| NO: 169 | | | | |
| SEQ ID | MID-22 | GCCTTGCCAGCCCGCTCAG | TACGAGTATG | CAGCCTCACATTGCCCC |
| NO: 170 | | | | |
| SEQ ID | MID-23 | GCCTTGCCAGCCCGCTCAG | TACTCTCGTG | CAGCCTCACATTGCCCC |
| NO: 171 | | | | |
| SEQ ID | MID-24 | GCCTTGCCAGCCCGCTCAG | TAGAGACGAG | CAGCCTCACATTGCCCC |
| NO: 172 | | | | |
| SEQ ID | MID-25 | GCCTTGCCAGCCCGCTCAG | TCGTCGCTCG | CAGCCTCACATTGCCCC |
| NO: 173 | | | | |
| SEQ ID | MID-26 | GCCTTGCCAGCCCGCTCAG | ACATACGCGT | CAGCCTCACATTGCCCC |
| NO: 174 | | | | |
| SEQ ID | MID-27 | GCCTTGCCAGCCCGCTCAG | ACGCGAGTAT | CAGCCTCACATTGCCCC |
| NO: 175 | | | | |
| SEQ ID | MID-28 | GCCTTGCCAGCCCGCTCAG | ACTACTATGT | CAGCCTCACATTGCCCC |
| NO: 176 | | | | |
| SEQ ID | MID-29 | GCCTTGCCAGCCCGCTCAG | ACTGTACAGT | CAGCCTCACATTGCCCC |
| NO: 177 | | | | |
| SEQ ID | MID-30 | GCCTTGCCAGCCCGCTCAG | AGACTATACT | CAGCCTCACATTGCCCC |
| NO: 178 | | | | |
| SEQ ID | MID-31 | GCCTTGCCAGCCCGCTCAG | AGCGTCGTCT | CAGCCTCACATTGCCCC |
| NO: 179 | | | | |
| SEQ ID | MID-32 | GCCTTGCCAGCCCGCTCAG | AGTACGCTAT | CAGCCTCACATTGCCCC |
| NO: 180 | | | | |
| SEQ ID | MID-33 | GCCTTGCCAGCCCGCTCAG | ATAGAGTACT | CAGCCTCACATTGCCCC |
| NO: 181 | | | | |
| SEQ ID | MID-34 | GCCTTGCCAGCCCGCTCAG | CACGCTACGT | CAGCCTCACATTGCCCC |
| NO: 182 | | | | |
| SEQ ID | MID-35 | GCCTTGCCAGCCCGCTCAG | CAGTAGACGT | CAGCCTCACATTGCCCC |
| NO: 183 | | | | |
| SEQ ID | MID-36 | GCCTTGCCAGCCCGCTCAG | CGACGTGACT | CAGCCTCACATTGCCCC |
| NO: 184 | | | | |
| SEQ ID | MID-37 | GCCTTGCCAGCCCGCTCAG | TACACACACT | CAGCCTCACATTGCCCC |
| NO: 185 | | | | |
| SEQ ID | MID-38 | GCCTTGCCAGCCCGCTCAG | TACACGTGAT | CAGCCTCACATTGCCCC |
| NO: 186 | | | | |
| SEQ ID | MID-39 | GCCTTGCCAGCCCGCTCAG | TACAGATCGT | CAGCCTCACATTGCCCC |
| NO: 187 | | | | |
| SEQ ID | MID-40 | GCCTTGCCAGCCCGCTCAG | TACGCTGTCT | CAGCCTCACATTGCCCC |
| NO: 188 | | | | |
| SEQ ID | MID-41 | GCCTTGCCAGCCCGCTCAG | TAGTGTAGAT | CAGCCTCACATTGCCCC |
| NO: 189 | | | | |
| SEQ ID | MID-42 | GCCTTGCCAGCCCGCTCAG | TCGATCACGT | CAGCCTCACATTGCCCC |
| NO: 190 | | | | |
| SEQ ID | MID-43 | GCCTTGCCAGCCCGCTCAG | TCGCACTAGT | CAGCCTCACATTGCCCC |
| NO: 191 | | | | |
| SEQ ID | MID-44 | GCCTTGCCAGCCCGCTCAG | TCTAGCGACT | CAGCCTCACATTGCCCC |
| NO: 192 | | | | |
| SEQ ID | MID-45 | GCCTTGCCAGCCCGCTCAG | TCTATACTAT | CAGCCTCACATTGCCCC |
| NO: 193 | | | | |
| SEQ ID | MID-46 | GCCTTGCCAGCCCGCTCAG | TGACGTATGT | CAGCCTCACATTGCCCC |
| NO: 194 | | | | |
| SEQ ID | MID-47 | GCCTTGCCAGCCCGCTCAG | TGTGAGTAGT | CAGCCTCACATTGCCCC |
| NO: 195 | | | | |
| SEQ ID | MID-48 | GCCTTGCCAGCCCGCTCAG | ACAGTATATA | CAGCCTCACATTGCCCC |
| NO: 196 | | | | |
| SEQ ID | MID-49 | GCCTTGCCAGCCCGCTCAG | ACGCGATCGA | CAGCCTCACATTGCCCC |
| NO: 197 | | | | |
| SEQ ID | MID-50 | GCCTTGCCAGCCCGCTCAG | ACTAGCAGTA | CAGCCTCACATTGCCCC |
| NO: 198 | | | | |
| SEQ ID | MID-51 | GCCTTGCCAGCCCGCTCAG | AGCTCACGTA | CAGCCTCACATTGCCCC |
| NO: 199 | | | | |
| SEQ ID | MID-52 | GCCTTGCCAGCCCGCTCAG | AGTATACATA | CAGCCTCACATTGCCCC |
| NO: 200 | | | | |

Master Mix Preparation: Once primers are designed, master mixes are prepared for the amplification of sample DNA. Master mixes can be prepared in bulk, stored at −20 C, and used for multiple batches of sample processing.

Although one master mix targets one gene of interest, multiple master mixes can be prepared to determine the mutation status of multiple genes of interest. A patient sample can be screened for multiple genetic markers by initial amplification with more than one master mix. If the master mixes are designed with the same MID combination, the data analysis software will combine the resulting mutation status data into one patient sample profile. This initial PCR amplification can also be multiplexed.

The master mix may be designed such that the combination of MID sequences can be used to identify each patient sample. In a batch of patient samples processed at the same time, each sample can be amplified by a unique master mix from the other samples that are sequenced in the same area of the Roche 454 PicoTitre sequencing plate. In some embodiments, each master mix uses the same MID sequence in both the forward and reverse primers. In other embodiments, a unique combination of forward and reverse MID sequences may be used. Despite variability in primer sequences between the master mixes, the buffer conditions, MgCl₂, and dNTP concentrations remain the same across all master mixes prepared.

The following table, Table 5, is an example of master mix designs, which allows for individual sample data analysis after multiplexing.

TABLE 5
Master Mix Design Examples

| Master Mix | Forward Primer | Reverse Primer | Sample |
|---|---|---|---|
| A | MID 1 | MID 1 | AA |
| B | MID 2 | MID 2 | BB |
| C | MID 2 | MID 1 | CC |

(After manufacturing, master mixes are tested with a wild-type cell line and water templates to confirm the absence of contamination.)

Sample DNA Extraction: Genomic DNA is extracted from patient blood or bone marrow using either the manual QIAamp DNA Blood Mini Kit or the automated QiaCube. Extracted sample genomic DNA is brought to a final concentration of 50 ng/ul.

Sample Amplification: Each patient sample is assigned to a master mix for the batch of samples processed. For a group of patient samples that will be processed at the same time, each sample is assigned to a master mix. As described above, the master mix assignments define the forward and reverse MID identifiers for de-multiplexing the resulting data. Patient genomic DNA is amplified with the associated master mixes using common thermocycling parameters, allowing multiple samples to be amplified simultaneously.

Sample Purification: After the patient DNA regions of interest have been amplified, the resulting DNA fragments are purified by magnetic beads using the Agencourt® AMPure® XP protocol.

Sample Quantification and Pooling: Purified sample DNA is quantified by NanoDrop technology and diluted to a concentration of 10⁹ molecules per microliter. Based on the PicoTiter Plate layout, described below, the samples are pooled in an equal volume ratio to prepare for the Roche 454 sequencing preparation protocols.

Pico Titer Plate Device Layout: The PicoTiter Plate Device used for Roche 454 sequencing can be prepared with 1 section for sample beads or divided into 2 or 4 sections. The sections can be utilized to separate the analysis for multiple genes of interest or to repeat master mix and MID combinations. The patient sample master mix and MID combination assignment cannot be duplicated within a section, yet it can be duplicated across sections. However, the PicoTiter Plate can accommodate the greatest number of sequence reads without the presence of section dividers.

Sequencing Preparation: Emulsion PCR; Technology utilizes the Fusion A and Fusion B segments of the sequencing primers; Amplicon is bound to beads; Amplified and washed. Forward and Reverse beads are prepared separately. Beads are pooled. Beads are loaded onto plate. Alternatively, a whole genome sequence of lymphoid cancer cells can be prepared by standard methodology.

Sequence Data Analysis: The resulting sequence data is analyzed using GS Amplicon Variant Analyzer software on a Linux operating system. A new project file is created and known reference sequences for the genetic loci of interest are imported. For each genetic marker tested, the expected amplicon is defined in the software by importing the gene specific portion of the forward and reverse primer sequences. The patient sample IDs or accession numbers are imported. Expected mutations, insertions, and deletions are entered into the software, although the final alignment analysis is able to detect deviations from the reference sequence without preliminary programming. The 10 base pair MID sequences are imported.

Once all of the above listed elements have been imported into the software, the multiplexer is defined to sort the sequence reads and assign those reads to the individual patients based on the MID sequence combinations. The resulting data is presented in a Variant (or mutation) table as well as graphically. The variant table includes a summary of the number of forward and reverse sequence read collected for each sample and target sequence. The mutation status of each clinical sample can be determined from this table since it also presents the number of sequence reads and percent for any predefined or newly detected variation from the reference sequence.

It should be emphasized that many variations and modifications may be made to the above-described embodiments, the elements of which are to be understood as being among other acceptable examples. All such modifications and variations are intended to be included herein within the scope of this disclosure and protected by the following claims.

### Example 2

### Whole Genome Sequence Analysis

Next generation sequencing enables the analysis of the complete genome, a subset of the genome and/or all or a subset of the protein and RNA coding regions (exome) from multiple individuals in parallel. There are several different platforms that can be used to generate biological data in the space of a relatively short time. These platforms include, but are not limited to, IIlumina Genome Analyzer, Roche 454 Sequencer, Applied BioSystems SOLiD and Ion-Torrent Personal Genome Machine. The basic process is similar for each of these instruments. As a non-limiting example, the Roche 454 process is described in more detail.

Genomic DNA is sheared so that the majority of the DNA fragments are less than 200 bp in length. Oligonucleotides are then ligated onto the 5′ end of the sheared genomic DNA. The ligated oligonucleotides act as templates for the primers used in the sequencing reactions. The ligated DNA is then bound to magnetic beads so that a single DNA molecule is bound to each bead. The beads are then emulsified with PCR amplification reagents so that a single bead is contained within a bubble of PCR reagents. The emulsion is broken and the beads washed. Beads without DNA are removed from the reaction and the beads with bound DNA are loaded onto plates with wells the size of beads so that one bead is in one well. The plate is then loaded onto the sequencing instrument and the sequencing reaction performed and the results detected according to the instrument protocol.

Each nucleotide base of the genome or exome may be sequenced multiple times, for example, over 20 times, to ensure accuracy. The sequencing results of the DNA fragments are assembled into a complete or partial sequence of the genome or exome of the sample by software that performs algorithms to align overlapping sequences.

A whole or partial genome or exome sequence (biological data) is obtained for an individual and is transmitted, for example, on data storage media for analysis. The biological data is analyzed by comparing the sample genome or exome to a database of licensed biomarkers. In some embodiments, the sample genome is compared to previously assembled genomes or exomes and polymorphisms are detected and then compared to a database of licensed biomarkers.

### Example 3

### Management of Biomarker and Biological Data Relationships

Individual biomarker databases are becoming more and more accessible through cloud and wireless healthcare connections and resources. It is possible to link, in real-time, individual biomarker databases with wireless healthcare resources, including real-time biometric readings, which enables the establishment of both dynamic, real-time computational and inter-relationships and notifications to patient, healthcare provider, and other interventional authorities or parties. Further, during epidemiological emergencies, biometric readings from individuals comprising a population can be used to alert healthcare authorities to locations that might be populated by persons affected by pathogens or pathogenic agents based upon individual responsive to pathogens (e.g., spike in their temperature) before individuals are aware of their infection and before the trend might otherwise be identified.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A system for analyzing biological data and managing associated fees, the system comprising:
a data store of biomarkers or association of biomarkers, at least one of the biomarkers or association of biomarkers being a licensed biomarker or association of biomarkers;
one or more computing devices in communications with the data store of biomarkers or association of biomarkers, the one or more computing devices operable to:
receive biological data;
obtain from the data store a set of biomarkers or association of biomarkers applicable to the biological data;
analyze the biological data and the set of applicable biomarkers or association of biomarkers to detect in the biological data the presence of at least one biomarker or association of biomarkers from the set of applicable biomarkers or association of biomarkers;
determine whether said at least one detected biomarker or association of biomarkers is a licensed biomarker or association of biomarkers;
generate licensing information for said at least one detected biomarker or association of biomarkers based at least in part on whether said at least one detected biomarker or association of biomarkers is a licensed biomarker or association of biomarkers.

2. The system of claim 1, wherein at least one of the biomarkers or association of biomarkers in the data store of biomarkers or association of biomarkers is at least one of a nucleic acid biomarker, a protein biomarker, a peptide biomarker, a carbohydrate biomarker, a metabolite biomarker, an antibody biomarker, an antigen biomarker or a lipid biomarker or association of biomarkers that may contain any of the above types of biomarkers and associated biometric data.

3. The system of claim 2, wherein the nucleic acid biomarker is at least one of a vertebrate nucleic acid biomarker or association of biomarkers, a mammalian nucleic acid biomarker or association of biomarkers, or a human nucleic acid biomarker or association of biomarkers.

4. The system of claim 1, wherein the received biological data comprises at least one of a whole genome sequence, a partial genome sequence, a whole exome sequence, a partial exome sequence, an RNA expression dataset, multiple nucleic acid sequences, a transcriptome, an antibody profile, a metabolome, an epigenome, a proteome, or other biometric or physiological data.

5. The system of claim 1, wherein the one or more computing devices are further operable to offer a license for said at least one detected biomarker or biomarker association to a customer via a customer computing device.

6. The system of claim 1, wherein the one or more computing devices are further operable to receive an acceptance by the customer of the offered license.

7. The system of claim 1, wherein the one or more computing devices are further operable to receive payment information from the customer in connection with acceptance of the offered license.

8. A computer-implemented method for analyzing biological data and managing associated fees, the method comprising:
under control of one or more computing devices,
electronically submitting biological data for detection of one or more biomarkers to a biomarker processing device, at least one of the one or more biomarkers being a licensed biomarker;
electronically receiving initial information regarding biomarkers detected in the submitted biological data by the biomarker processing device, the initial information regarding detected biomarkers comprising at least licensing information associated with biomarkers detected in the submitted biological data;
electronically submitting payment of a licensing fee associated with one or more of the biomarkers or biomarker association detected in the submitted biological data; and
receiving additional biomarker or biomarker association information regarding the biomarkers or biomarker association detected in the submitted biological data, the additional information regarding the detected biomarkers or biomarker association comprising at least identification information associated with the biomarkers or biomarker association detected in the submitted biological data.

9. The method of claim 8, wherein at least one biomarker or biomarker association is a nucleic acid biomarker, a protein biomarker, a peptide biomarker, a carbohydrate biomarker, a metabolite biomarker, an antibody biomarker, an antigen biomarker, a lipid biomarker or an association of any of these afore mentioned biomarkers.

10. The method of claim 8, wherein the biological data comprises at least one of a whole genome sequence, a partial genome sequence, a whole exome sequence, a partial exome sequence, an RNA expression dataset, multiple nucleic acid sequences, a transcriptome, an antibody profile, a metabolome, an epigenome, a proteome, or biometric or other physiological data.

11. The method of claim 8, where receiving additional biomarker or biomarker association information regarding the one or more biomarkers or biomarker association detected in the submitted biological data comprises receiving at least one of diagnosis or treatment information determined based at least in part on the one or more biomarkers or biomarker association detected in the submitted biological data.

12. The method of claim 8, further comprising submitting a biological sample for processing in order to determine the biological data.

13. A computer-implemented method for analyzing a sequence information and managing associated fees, the method comprising:
under control of one more computing devices,
receiving or generating sequence information related to biological data;
accessing licensed biomarker or biomarker association data from a data store of licensed biomarker data;
analyzing the received sequence information and the accessed licensed biomarker or biomarker association data to detect the presence of at least one biomarker or biomarker association in the biological data; and
generating licensing or payment information for said at least one detected biomarker or biomarker association.

14. The method of claim 13, further comprising:
offering a license to a customer associated with the sequence information related to the biological data;
receiving an acceptance of the license by the customer; and
transmitting to a customer computing device associated with the customer additional biomarker or biomarker association information regarding the at least one biomarker or biomarker association detected in the biological data, the additional information regarding the at least one detected biomarker or biomarker association comprising at least identification information associated with the at least one biomarker or biomarker association detected in the biological data.

15. The method of claim 13, wherein receiving sequence information related to biological data comprises generating the sequence information related to the biological data.

16. The method of claim 13, further comprising determining at least one of diagnosis or treatment information based at least in part on the at least one biomarker or biomarker association detected in the sequence information.

17. A system for managing fees associated with use of biomarkers or association of biomarkers, the system comprising:
one or more computing devices configured to:
submit sequence information related to biological data;
receive information regarding one or more biomarkers or biomarker association detected within the sequence information, said one or more biomarkers or biomarker association subject to use restrictions; and
receive licensing information associated with the one or more detected biomarkers or biomarker association subject to use restrictions.

18. The system of claim 17, wherein the one or more computing devices are further configured to receive an offer for at least one license corresponding to the license information, and transmit an acceptance of the at least one license.

19. The system of claim 18, wherein the one or more computing devices are further configured to receive additional biomarker or biomarker association information regarding the one or more biomarkers or biomarker association detected in the sequencing information, the additional information regarding the one or more biomarkers or biomarker association comprising at least identification information associated with the one or more biomarkers or biomarker association detected in the sequencing information.
